(19) United States
(12) Patent Application Publication
(10) Pub. No.: US 2004/0091646 A1
(43) Pub. Date: May 13, 2004

(54) Ink-jet recording sheet

(75) Inventors: Yukako Taka, Tokyo (JP); Yoshinori Tsubaki, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KONICA MINOLTA HOLDINGS, INC., Tokyo (JP)

(21) Appl. No.: 10/699,343

(22) Filed: Oct. 30, 2003

(30) Foreign Application Priority Data
Nov. 8, 2002 (JP) JP2002-324623

(51) Int. Cl. B41M 5/00

(52) U.S. Cl. 428/32.1

(57) ABSTRACT

An ink-jet recording sheet is disclosed. The ink accepting porous layer comprises a hydrophilic binder containing a polymer compound crosslinked via irradiation of ionizing radiation, micro particles, and at least one component selected from the group consisting of (A) a nitrogen-containing compound, (B) a sulfur-containing compound, (C) a phenol compound and (D) a polyvalent metal salt.

### FIELD OF THE INVENTION

The present invention relates to an ink-jet recording sheet, hereinafter also referred simply to as a recording sheet.

### BACKGROUND OF THE INVENTION

The quality of printed images via ink-jet printing is being made equal to that of prints formed by silver halide photography, due to rapid progress of technology of ink-jet recording. The quality of images formed by ink-jet printing depends on the printer, ink and recording sheet. Regarding image quality, the contribution of technological innovation of the former two is significant. Consequently, the importance of the quality of the recording sheet is made to be considerably higher.

Hitherto, various improvements have been applied to recording sheets to obtain printed image quality approaching that of photographic prints. Particularly, recording sheets composed of a paper support covered on the both sides thereof with polyolefin resin such as polyethylene has recently been widely enlarged since prints using such sheets have high class feeling similar to silver halide photographic prints in the depth, flexibility, smoothness and glossiness.

A swelling type ink accepting porous layer and a porous type ink accepting porous layer are known as an ink accepting porous layer which can be provided on a support.

The swelling type ink accepting porous layer is basically constituted of hydrophilic polymer such as polyvinyl alcohol, polyvinyl pyrrolidone and polyethylene oxide. The swelling type ink accepting porous layer has features such as high glossiness can be obtained, a large amount of ink can be absorbed within the swellable range of the polymer since swellable polymer is used, and the sheet can be produced at low cost.

As a typical example, a recording sheet for an aqueous ink having an ink accepting porous layer is proposed which contains hydrophilic resin crosslinked by irradiation of ionizing radiation, compare to referred patent document 1. However, there is a problem in that the ink absorbability is lowered when the crosslinked resin is used to absorb the ink in the swelling type ink accepting porous layer.

On the other hand, a porous type ink accepting porous layer can be produced by several methods, and a typical one of these is a layer constituted by a small amount of hydrophilic polymer and a large amount of micro particles. In such a layer, pores are formed and the ink is absorbed in them. The features of such a layer are that unevenness of printed images occurs; the surface of the printed image is only seemingly dried just after the printing; and both water proofing and ink absorption rate are simultaneously satisfied contrary to that which occurs in the case of swelling type sheet.

For example, a method has been proposed in which a coating liquid composed of inorganic sol and an ionizing radiation hardenable monomer/oligomer compound is coated and dried to prevent occurrence of defect of the coated layer such as mottling or cracking of the coated layer and to improve strength of the layer such as resistance to water and subsequent damage and ink absorption ability, compare to referred patent document 2. However, the technology disclosed in the document is insufficient to improve light fastness of color, and weather proofing.

Referred patent document 1:

Japanese Patent Publication Open to Public Inspection, hereinafter referred to as Japanese Patent O.P.I. Publication, No. 1-286886

Referred patent document 2:

Japanese Patent O.P.I. Publication, No. 9-263038

### SUMMARY OF THE INVENTION

The objective of the present invention is to provide an ink-jet recording sheet with high ink absorption, in which the resistance to color fading by light is excellent; the weather proofing ability is high; and occurrence of cracking in the production processes such as coating and drying and that fractures caused by bending in the course of handling after drying are prevented.

The inventors have found that the above-mentioned object of the invention can be attained by the following means.

1. An ink-jet recording sheet comprising a support and an ink accepting porous layer provided on the support, wherein the ink accepting porous layer comprises a hydrophilic binder containing a polymer compound crosslinked via irradiation of ionizing radiation, micro particles, and at least one component selected from the group consisting of (A) a nitrogen-containing compound, (B) a sulfur-containing compound, (C) a phenol compound and (D) a polyvalent metal salt.

2. The ink-jet recording sheet of Item 1, wherein the micro particles have an average diameter of from 5 to 200 nm.

3. The ink-jet recording sheet of Item 1 or 2, wherein a ratio of the micro particles to the hydrophilic binder is from 1:2 to 1:50 by weight.

4. The ink-jet recording sheet of Item 3, wherein the ratio of the micro particles to the hydrophilic binder is from 1:5 to 1:15 by weight.

5. The ink-jet recording sheet of any one of Items 1 to 4, wherein the polymer compound crosslinked via irradiation of ionizing radiation is a polymer compound formed by crosslinking a hydrophilic resin having a diner formable photosensitive group formed via irradiation of ionizing radiation.

6. The ink-jet recording sheet of any one of Items 1 to 5, wherein the nitrogen-containing compound is at least one selected from the group consisting of a hindered amine compound, a hydroxylamine compound and a water-soluble aliphatic tertiary amine compound.

7. The ink-jet recording sheet of any one of Items 1 to 6, wherein the nitrogen containing compound is a polyallylamine compound.

8. The ink-jet recording sheet of any one of Items 1 to 6, wherein the nitrogen-containing compound is a tertiary amine compound.

9. The ink-jet recording sheet of any one of Items 1 to 6, wherein the sulfur compound is a compound represented by Formula 1 or Formula 2:

R—S—R′ Formula 1

wherein R and R′ are each an alkyl group or an aryl group,

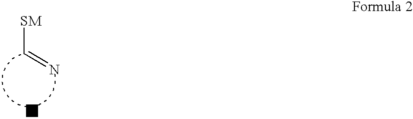

wherein M is a hydrogen atom, an ammonium ion or a metal atom; X is a group of non-metal atoms necessary to form a five- through seven-member ring.

10. The ink-jet recording sheet of any one of Items 1 to 5, wherein the polyvalent metal salt is a water-soluble salt of one selected from the group consisting of cesium, magnesium, aluminum and zirconium.

11. The ink-jet recording sheet of any one of Items 1 to 5, wherein the phenol compound is a hindered phenol compound or a hydroquinone diether compound.

12. The ink-jet recording sheet of any one of Items 1 to 12, wherein the polymer compound is a polymer compound crosslinked through side chains of a hydrophilic polymer compound by irradiation via ionizing radiation, the hydrophilic compound having a polymerization degree of not less than 300 and the plurality of side chains on a main chain.

13. The ink-jet recording sheet of any one of Items 1 to 12, wherein the ink accepting porous layer further comprises polyvinyl alcohol or its derivative.

14. A preparation method of an ink-jet recording sheet comprising a step of (a) forming a porous layer on a support in which the porous layer comprises a hydrophilic binder containing a polymer compound crosslinked via irradiation of ionizing radiation, micro particles, and at least one component selected from the group consisting of (A) a nitrogen-containing compound, (B) a sulfur-containing compound, (C) a phenol compound and (D) a polyvalent metal salt.

15. The preparation method of item 14, wherein the step of (a) forming a porous layer comprises the steps;

(b) forming a coated film comprising a polymer compound and micro particles, on the support, and

(C) crosslinking the polymer compound via irradiation of ionizing radiation to the polymer compound.

16. The preparation method of item 15, wherein the step of (a) forming a porous layer comprises, after the step (c), the step;

(d) providing coated film with the a coating liquid containing at least one component selected from the group consisting of (A) a nitrogen-containing compound, (B) a sulfur-containing compound, (C) a phenol compound and (D) a polyvalent metal salt.

17. The preparation method of item 16, wherein the step of (d) is conducted after a time that water content of the coated film becomes less than the volume of pores in the ink accepting porous layer, during drying of the coated film, or after completion of drying of the coated film.

18. The preparation method of item 16, wherein the step of (d) is conducted after completion of drying of the coated film.

19. The preparation method of any one of Items 16 to 18, wherein the polymer compound crosslinked by irradiation via ionizing radiation is a polymer compound formed by crosslinking a hydrophilic resin having a dimer formable photosensitive group formed via irradiation of ionizing radiation.

20. The preparation method of any one of Items 16 to 19, wherein the nitrogen-containing compound is at least one selected from the group consisting of a hindered amine compound, a hydroxylamine compound and a water-soluble aliphatic tertiary amine compound.

21. The preparation method of any one of Items 16 to 18, wherein the nitrogen-containing compound is a polyallylamine compound.

22. The preparation method of Item 20, wherein the nitrogen-containing compound is a tertiary amine compound.

23. The preparation method of any one of Items 16 to 19, wherein the sulfur compound is a compound represented by Formula 1 or Formula 2:

R—S—R′ Formula 1

wherein R and R′ are each an alkyl group or an aryl group,

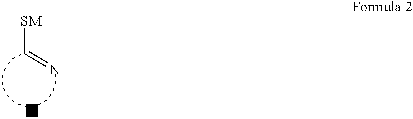

wherein M is a hydrogen atom, an ammonium ion or a metal atom; X is a group of non-metal atoms necessary to form a five- through seven-member ring.

24. The preparation method of any one of Items 16 to 19, wherein the polyvalent metal salt is a water-soluble salt of one selected from the group consisting of cesium, magnesium, aluminum and zirconium.

25. The preparation method of any one of Items 16 to 19, wherein the phenol compound is a hindered phenol compound or a hydroquinone diether compound.

26. The preparation method of any one of Items 16 to 19, wherein the polymer compound is a polymer compound crosslinked through side chains of a hydrophilic polymer compound having a polymerization degree of not less than 300 and the plurality of side chains on a main chain by irradiation via ionizing radiation.

27. The preparation method of any one of Items 16 to 26, wherein the ink accepting porous layer further comprises polyvinyl alcohol or its derivative.

It is assumed that ink-jet recording sheets exhibiting high ink absorbability, in which the resistance to color fading by light is excellent, weather proofing ability is high, the occurrence of cracking in the production processes such as coating and drying and fractures caused by bending in the course of handling after drying are prevented can be provided by the following reason.

Hydrophilic binders crosslinked by irradiation via ionizing radiation are instable in the independent state. However, such binders can be stabilized by being combined with at least one component selected from the group consisting of (A) a nitrogen-containing compound, (B) a sulfur-containing compound, (C) a phenol compound and (D) a poly-valent metal salt, and the light fastness of color and the weather proofing ability of the binders are improved. Usually, the hydrophilic binder is hardened by a crosslinking agent or hardening agent to raise the layer strength by crosslinking. However, problems such as cracking occurring during coating and drying and the fractures due to bending tend to be formed by excessive hardness of the layer when such hardeners are used. On the other hand, ink-jet recording sheet with high ink absorbability and without formation of the cracking and fractures caused by bending can be obtained when the hydrophilic binders contain a polymer compound crosslinked by irradiation via ionizing radiation, which seem to work together when a hardener is used with at least one of the compounds selected from the group consisting of (A) a nitrogen-containing compound, (B) a sulfur-containing compound, (C) a phenol compound and (D) a poly-valent metal salt.

### DETAILED DESCRIPTION OF THE INVENTION

The present invention is described in detail below.

The ink jet recording sheet of the present invention comprises an ink accepting porous layer provided on a support, in which the ink accepting porous layer comprises a hydrophilic binder containing a polymer compound crosslinked via irradiation of ionizing radiation, micro particles, and at least one component selected from the group consisting of (A) a nitrogen-containing compound, (B) a sulfur-containing compound, (C) a phenol compound and (D) a polyvalent metal salt.

The ink accepting porous layer is a layer having pores, pore volume per unit area being 15-40 ml/m². The volume of the void was determined by the amount of liquid transfer during the contact time of 2 seconds according to the test method of liquid absorption of paper and cardboard (Bristow method) defined in J. TAPPI 51.

A polymer compound which forms crosslinking via irradiation of ionizing radiation is described.

Examples of resins capable of crosslinking by irradiation via ionizing radiation include a photo-dimerizable resin, a photo-decomposable resin, a photo-modifying resin and a photo-depolymerizable resin. The photo-dimerizable resins are preferred in the invention. As a photo-dimerizable resin, ones in which a diazo group, a cinnamoyl group, a stilbazonium group or a stilquinolium group is introduced are preferable.

Further, it is preferable that the hydrophilic polymer is resin which are dyed with water-soluble dyes such as anionic dyes after photo-crosslinking. Listed as such resins are, for example, resins having a cationic group such as a primary amino group and a quaternary ammonium group, photosensitive resins (being compositions) described, for example, in Japanese Patent Application Open to Public Publications 56-67309, 60-129742, 60-252341, 62-283339, and 1-198615, resins having a group such as an azide group which is converted to an amino group through a curing treatment, while becoming cationic, and photosensitive resins (being compositions) described, for example, in Japanese Patent Application Open to Public Inspection No. 56-67309.

Tendency to form the braking by bending during the storage can be inhibited by the polymer compound capable of crosslinking by the irradiation of ionizing radiation according to the invention since any polymerization initiator or polymerization forbidding agent is substantially not necessary for crosslinking and generation of un-reacted free radical after irradiation by the ionizing radiation can be inhibited. Examples of such the polymer compound include a saponification product of poly(vinyl acetate), poly(vinyl acetal), poly(ethylene oxide), poly(alkylene oxide), poly(vinyl pyrrolidone), polyacrylamide, hydroxyethyl cellulose, methyl cellulose, hydroxypropyl cellulose, a copolymer of them, and ones having a main chain hydrophilic resin derivative and a side chain of the foregoing crosslinkable group.

The polymer compound relating to the invention which forms crosslink by the irradiation by the ionizing radiation is the resin capable of crosslinking by irradiation by the ionizing radiation such as ultraviolet rays and electron rays. It is preferable that such the resin is one capable becoming sparingly soluble in water after crosslinking compared to before crosslinking. Such the polymer compound is preferably a hydrophilic polymer compound having an average polymerization degree of not less than 300, preferably not less than 400, more preferably not less than 1,000, which has plural side chains on the main chain and is capable of forming crosslink by irradiation by the ionizing radiation. Upper limit of the average polymerization degree is about 4,000, even though there is no upper limitation on the average polymerization degree. The average polymerization degree of the polymer compound crosslinkable by irradiation by the ionizing radiation can be determined by viscosity average polymerization degree according to the viscosity of the solution of the polymer compound before decorating by the crosslinkable group. For example, when poly(vinyl alcohol) is used, the polymerization degree can be determined according to the method described in JIS K-6726.

In the present invention, preferably employed are photosensitive resins described in Japanese Patent Application Open to Public Inspection No. 56-67309. The aforesaid resins include resin compositions having a 2-azido-5-nitrophenylcarbonyloxyethylene structure represented by Formula (I), described below, or a 4-azido-3-nitrophenylcarbonyloxyethylene structure represented by Formula (II), also described below, in a polyvinyl alcohol structure.

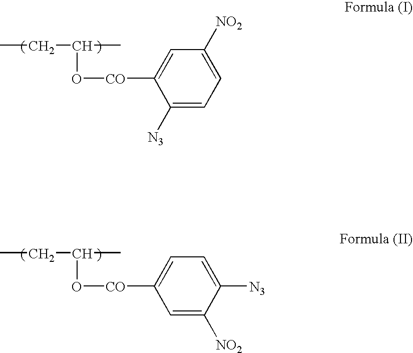

Specific examples of the aforesaid resins are described in Examples 1 and 2 of the aforesaid patent publication, while constitution components and their used ratio are described on page 2 thereof.

Further, Japanese Patent Application Open to Public Inspection No. 60-129742 describes photosensitive resins which include polyvinyl alcohol based resins having the structural units represented by Formula (III) or (IV), described below, in the polyvinyl alcohol structure;

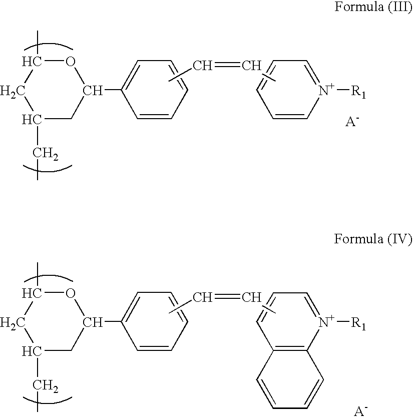

wherein R₁ represents an alkyl group having 1-4 carbon atoms, and A⁻ represents an anion. These are polyvinyl alcohol based resins having structural units comprising a styrylpyridinium (stilbazolium) structure or a styrylquinolinium structure, which are prepared by allowing polyvinyl alcohol or partially saponified polyvinyl acetate to react with a styrylpyridinium salt or a styrylquinolinium salt. The production method of these is described in Japanese Patent Application Open to Public Inspection No. 60-129742 and is easily produced with reference to the aforesaid patent publication.

The ratio of a styrylpyridinium group or a styrylquinolinium group in polyvinyl alcohol having the styrylpyridinium group or the styrylquinolinium group is preferably 0.2-10.0 mol percent per polyvinyl alcohol unit. The more photosensitive units are introduced, the higher the speed. When the aforesaid constitution units are introduced into polyvinyl alcohol of not more than 10.0 mol percent, the resulting resins can be dissolved in water. On the other hand, when the ratio is more than 0.2 percent, the effects of the present invention are achieved due to sufficient strength after crosslinking.

The network structure of the porous layer according to the invention can be easily hold many fine particles since such the layer contains the binder containing the polymer compound formed by crosslinking through the side chains by irradiating the ionizing radiation to the hydrophilic polymer compound having plural side chains on the main chain thereof and a polymerization degree of not less than 300 which has a long distance crosslinkage different from the relatively short distance crosslinkage of the three dimensional structure in the porous network formed by crosslinking by only use of a crosslinking agent or that formed by crosslinking by the irradiation of the ionizing radiation to a hydrophilic polymer compound having no plural side chains or a polymer compound having a lower polymerization degree. Consequently, a uniform porous layer can be formed by a smaller amount of the binder namely by a smaller ratio of the binder to the amount of the fine particles.

The void ratio (i.e. the ratio of pore space) in the ink-jet recording layer can be raised and the ink is more easily held in the layers when the ratio of the binder to the fine particles is smaller. Accordingly, the overflow of the ink can be prevented. Thus the ink-jet recording sheet having a porous layer can be obtained, which can be rapidly dried and has high strength of the coated layer and high resistivity against folding. Furthermore, the porous layer has high resistivity against cracking and peeling off the layer and to stress caused by folding before and after printing of image.

Therefore, an ink-jet recording sheet can be obtained, which has high ink absorbability and improved resistively to water and inhibited occurrence of fissures caused by folding and cracks.

The ratio of fine particles and the hydrophilic binders of the porous layer is preferably from 2:1 to 50:1 in terms of weight ratio. When said weight ratio is less than 2:1, the desired void ratio of the porous layer is obtained. As a result, it is possible to obtain the sufficient void volume easily. In addition, it is able to reduce that excessive hydrophilic binders swell during ink jet recording and block voids (i.e. the space of pores), becoming a factor in the decrease of the ink absorption rate. On the other hand, when said ratio is not more than 50:1, it is able to reduce that undesirable cracking tends to occur during coating a relatively thick porous layer. The ratio of fine particles and said hydrophilic binders is preferably from 6:1 to 15:1 in view of avoiding breaking of dried coat by folding.

In the invention, the fine particles form the space of pores in the porous layer together with the polymer compound formed by crosslinking through the side chains of the hydrophilic polymer compound having the plural side chains on the main chain thereof and a polymerization degree of not less than 300 by the irradiation of the ionizing radiation. As the fine particle to be contained in the porous layer, inorganic particles are preferably used since further small particle can be easily obtained, and the recording paper with high glossiness and a high density printed image can be obtained even though an organic particle may also be used.

Listed as said inorganic particles may be, for example, white inorganic pigments such as precipitated calcium carbonate, heavy calcium carbonate, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatomaceous earth, calcium silicate, magnesium silicate, synthetic non-crystalline silica, colloidal silica, alumina, colloidal alumina, pseudo-boehmite, aluminum hydroxide, lithopone, zeolite, and magnesium hydroxide. Primary particles of said fine inorganic particles may be employed without any further modification, and said inorganic particles may also be employed in the state in which secondary coagulated particles are formed.

In the present invention, from the viewpoint of preparing high quality prints utilizing ink jet recording sheets, preferred as fine inorganic particles are alumina, pseudo-boehmite, colloidal silica, and fine silica particles synthesized employing a gas phase method. Of these, fine silica particles synthesized employing a gas phase method are particularly preferred. Said silica synthesized employing a gas phase method, whose surface is modified with aluminum may be employed. The content ratio of aluminum in the gas phase method silica whose surface is modified with aluminum is preferably from 0.05 to 5 percent by weight with respect to the total silica.

When the organic particle is used in the porous layer as the fine particle, a fine particle is preferably used, which is obtained by emulsion polymerization of a monomer selected from the group consisting of an alkyl acrylate, an alkyl methacrylate, styrene and a styrene derivative using a emulsifying agent having one or more carbon-carbon double bonds in the molecule thereof.

The diameter of the inorganic micro particle is preferably not more than 200 nm from the viewpoint of glossiness and color appearance even though particles having any diameter may be used. The particle diameter is preferably not less than 5 nm from the viewpoint of production even though there is no specific limitation to the lower limit of particle diameter. The average diameter of these inorganic micro particles is defined by a simple average or number average of the diameters of 100 randomly selected particles, the averages being obtained by electron microscopic observation of the cross section or the surface of the porous ink accepting porous layer. The particle diameter is represented by the diameter of the area of a circle having an area equal to the projection area of an individual particle.

Further, from the viewpoint of glossiness as well as color forming properties, the degree of dispersion of fine particles in the porous layer is preferably no more than 0.5. When said degree of dispersion is not more than 0.5, the resulting glossiness as well as color forming properties of the image printed is sufficiently obtained. The degree of dispersion of fine particles, as described herein, refers to the value obtained by dividing the standard deviation of the particle diameter by the average particle diameter which is determined by observing the fine particles of the porous layer in the same manner as for determining the aforesaid average particle diameter.

Said fine particles may be located in the porous layer in the form of primary particles which are not subjected to any modification, secondary particles, or higher order coagulated particles. However, said average particle diameter refers to the average diameter of particles which form independent particles in the porous layer when observed with an electron microscope.

The content of said fine particles in the water-soluble coating composition for forming the porous layer is preferably from 5 to 40 percent by weight, and is more preferably from 7 to 30 percent by weight.

The ratio of micro particles to the hydrophilic binder contained in the ink accepting porous layer is preferably from 2 to 50 by weight. When the ratio is not less than 2, the space ratio in the porous ink accepting porous layer is sufficient and the blocking of pores by swelling of excessive hydrophilic binder can be prevented during ink-jet recording. When the ratio is not more than 50, the fractures due to bending cause problems when a thick porous ink accepting porous layer is applied. Ratio of micro particles to the hydrophilic binder of from 5 to 15 is particularly preferable since the fractures due to bending in the dried layer is prevented.

The ink accepting capacity per unit area of the porous ink accepting porous layer according to the invention is preferably from about 15 to 40 ml/m². Absorbing capacity is defined by the volume of bubbles formed when the unit volume of the coated layer is immersed in water, or by the volume of water to fully saturate the coated layer.

A hydrophilic binder can be employed in addition to a polymer compound crosslinked via irradiation of ionizing radiation as far as it does not deteriorate the characteristics of the recording sheet. Hydrophilic binders are not particularly limited, and any of those, may be employed. For example, employed may be gelatin, polyvinylpyrrolidone, polyethylene oxide, polyacrylamide, and polyvinyl alcohol. Of these, polyvinyl alcohol or its derivative is particularly preferred.

Polyvinyl alcohol is a polymer whose hygroscopic properties exhibit a relatively small dependence on humidity, and whose contraction stress during coating and drying is also relatively small. As a result, polyvinyl alcohol is excellent in minimizing cracking during coating and drying, which is the problem to be solved by the present invention. Polyvinyl alcohol preferably employed in the present invention includes common polyvinyl alcohol which is prepared by hydrolyzing polyvinyl acetate and also modified polyvinyl alcohol such as polyvinyl alcohol whose terminals have been subjected to cation modification and anion-modified polyvinyl alcohol having an anionic group.

The average degree of polymerization of said polyvinyl alcohol prepared by hydrolyzing vinyl acetate is preferably at least 300, and is more preferably from 1,000 to 5,000. The saponification ratio of said polyvinyl alcohol is preferably from 70 to 100 percent, and is more preferably from 80 to 99.5 percent.

Said cation-modified polyvinyl alcohol includes, for example, polyvinyl alcohol which has a primary, secondary or tertiary amino group, or a quaternary ammonium group in the main or side chain of said polyvinyl alcohol, as described in Japanese Patent Publication Open to Public Inspection No. 61-10483. Said polyvinyl alcohol is prepared by saponifying the copolymer of an ethylenic unsaturated monomer having a cationic group and vinyl acetate.

Examples of ethylenic unsaturated monomer include trimethyl(2-acrylamido-2,2-dimethylethyl)ammonium chloride, N-vinylimidazole, N-vinyl-2-methylimidazole, N-(3-dimethylaminopropyl)methacrylamide, hydroxyethyl trimethylammonium chloride, trimethyl(methacrylamidopropyl)ammonium chloride, and N-(1,1-dimethyl-3-dimethylaminopropyl)acrylamide.

The ratio of the monomer having a cationic modifying group in the cationic modified polyvinyl alcohol to vinyl acetate is from 0.1 to 10 mole percent, preferably from 0.2 to 5 mole percent.

Examples of anionic modified polyvinyl alcohol include the polyvinyl alcohol having an anionic group described in Japanese Patent O.P.I. Publication No. 1-206088, a copolymer of vinyl alcohol and vinyl compound having a water-solubilizing group described in Japanese Patent O.P.I. Publication Nos. 61-237681 and 63-307979 and a modified polyvinyl alcohol having a water-solubilizing group described in Japanese Patent O.P.I. Publication No. 7-285265.

Examples of nonionic modified polyvinyl alcohol include the polyvinyl alcohol derivatives in which a poly(alkylene oxide) group is added to a part of the polyvinyl alcohol described in Japanese Patent O.P.I. Publication No. 7-9758, and a block copolymer of a vinyl compound having a hydrophobic group and vinyl(alcohol) described in Japanese Patent O.P.I. Publication No. 8-25795.

Two or more kinds of these polyvinyl alcohols, each different from the others in the polymerization degree or type of modification may be used in combination.

Next, (A) the nitrogen-containing compound, (B) the sulfur-containing compound, (C) a phenol compound and (D) a polyvalent metal salt, relating to the invention are described.

(A) Nitrogen-Containing Compound

As the nitrogen-containing compound, those described in Japanese Patent O.P.I. Publications 2000-263918, 2001-139851, 2001-341418, 2002-19267, 2001-191640, 2000-271499, 62-37181, 62-37182, 62-37183, 61-164989, 59-96987 and 61-146591 can be used. Among these, hindered amine compounds typified by 2,2,6,6-tetramethylpiperidine having a substituent at the 4-site, hydroxylamine compounds, water-soluble aliphatic tertiary amine compounds, polyallylamine compounds and polyvinyl amine compounds are cited as particularly preferred nitrogen-containing compound. More preferable examples are water-soluble aliphatic tertiary amine compounds, polyallylamine compounds, and particularly preferable examples are polyallylamine compounds. Further, Adecastarb LA-52 produced by Asahi Denka Co., Ltd., Syasorb UV-3346, produced by Sytech Co., Ltd., Sumisoap 577, produced by Sumitomo Kagaku Kogyo Co., Ltd., N,N-bis-sulfoethylhydroxylamine and triethanol amine are obtained in market.

The polyarylamines are polyarylamines represented by the following Formula PA-1, polydiarylamines represented by the following Formula PA-2 or PA-3, polydiarylamine derivatives represented by the following Formula PA-4 or PA-5, and polymers of them.

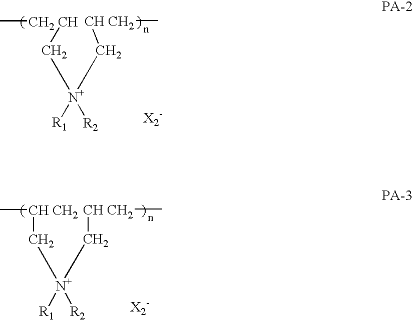

In Formula PA-1, n is an integer of from 5 to 10,000, and X⁻ is a residue of inorganic or organic acid.

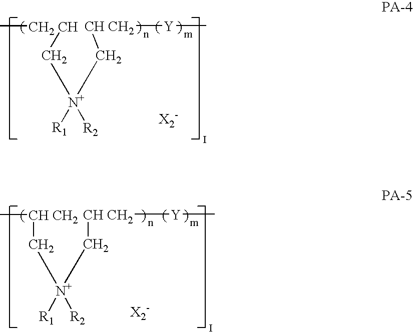

In Formulas PA-2 through PA-5, R¹ and R² are each a hydrogen atom, a methyl group, an ethyl group or a hydroxyl group, X²⁻ is a residue of inorganic or organic acid, and Y is a di-valent linking group; and n/m is from 9/1 to 2/8, and 1 is an integer of from 5 to 10,000.

Concrete examples of the polydiarylamine represented by Formula PA-4 or PA-5 included ones represented by the formula described in Japanese Patent Publication Open to Public Inspection No. 60-83883 which each contains an SO₂ group in the repeating unit thereof, copolymers with acrylamide described on page 2 of Japanese Patent Publication Open to Public Inspection No. 1-9776, and copolymers with the polydiarylamine represented by Formula PA-4 or PA-5 according to the invention.

In the invention, ones sold by Nittou Bouseki Co, Ltd with the commercial name of PAA-HCl-10L, PAA-D11-HCL and PAA-05 are preferably usable.

The added amount of the nitrogen-containing compound to the porous ink accepting porous layer is preferably from 0.01 g to 3 g per m² of the ink-jet recording sheet, even though the added amount is not specifically limited. When the amount is not more than 3 g, blocking of the pores in the porous ink accepting porous layer by such a compound is inhibited to maintain the high ink absorbing ability. When the amount is not less than 0.01 g, the effects of the invention are sufficiently enhanced. From such a viewpoint, a compound is preferably used within the range of from 0.1 to 2 g per m² of the ink-jet recording sheet.

(B) Sulfur-Containing Compound

As the sulfur-containing compound, those described in Japanese Patent O.P.I. Publications 61-177279, 61-136886, 64-36479, 7-314883, 7-314882, 1-115677, 8-25679, 10-330644, and 2001-170136 can be used. Among these, ones represented by the foregoing Formula 1 or 2 are particularly preferable sulfur-containing compounds. R—S—R′ Formula 1

wherein R and R′ are each an alkyl group or an aryl group,

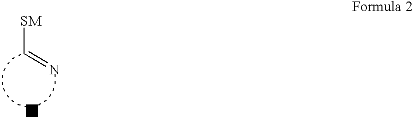

wherein M is a hydrogen atom, an ammonium ion or a metal atom; X is a group of non-metal atoms necessary to form a five- through seven-member ring.

In Formula 1, the alkyl group represented by R or R′ is a substituted or unsubstituted alkyl group. Examples of these substituents include a hydroxyl group, an aryl group, an alkoxyl group, an alkylthio group, an amino group, a mercapto group, a carboxyl group, a sulfo group, an acyl group, a carbamoyl group, a sulfamoyl group, and a halogen atom. Specific examples of compound represented by Formula 1 are shown below.

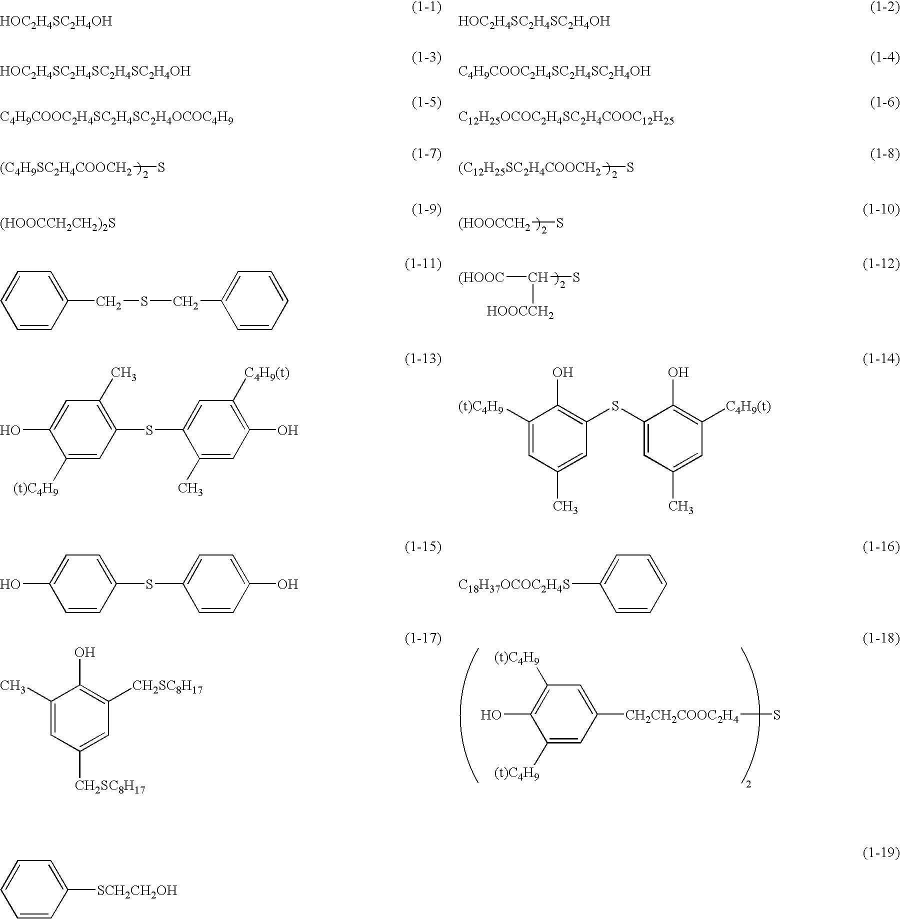

Among the foregoing compounds, the water-soluble thioether compounds are preferred. Compounds having at least one water-solubilizing group such as a hydroxyl group or a sulfo group are particularly preferred.

In the compounds represented by Formula 2, five-through seven-member rings composed of the group of non-metal atoms represented by X is preferably a five-member azole. Preferable examples of azole rings include single rings such as a pyrrole ring, a pyrazole ring, an imidazole ring, a triazole ring, a tetrazole ring, an oxazole ring, a thiazole ring, a thiadiazole ring, a selenazole ring, and a tellurazole ring, as well as a condensed ring such as an indole ring, an indazole ring, a purine ring, a benzimidazole, a benzotriazole ring, a benzoxazole ring, a benzothiazole ring, a naphthoimidazole ring, and a naphthothiazole ring. Other than the above, six-member rings such as a pyridine ring, a pyrimidine ring, a pyrazine ring, a pyridazine ring, and an s-triazine and their condensed rings such as a quinoline ring, an iso-quinoline ring, a phthalazine ring, a quinoquizaline ring, and a quinazoline ring, and seven-member rings such as azepine and benzodiazepine are cited as preferable ones.

The foregoing rings each may have a substituent. Examples of the substituent include an alkyl group, an alkenyl group, an aryl group, an alkoxyl group, an aryloxy group, an alkylthio group, an arylthio group, a hydroxyl group, and amino group, a mercapto group, a carboxyl group, an acyl group, a carbamoyl group, a sulfamoyl group, a halogen atom, and a cyano group. Each of these substituents may further have a substituent.

Specific examples of the compounds represented by Formula 2 are shown below.

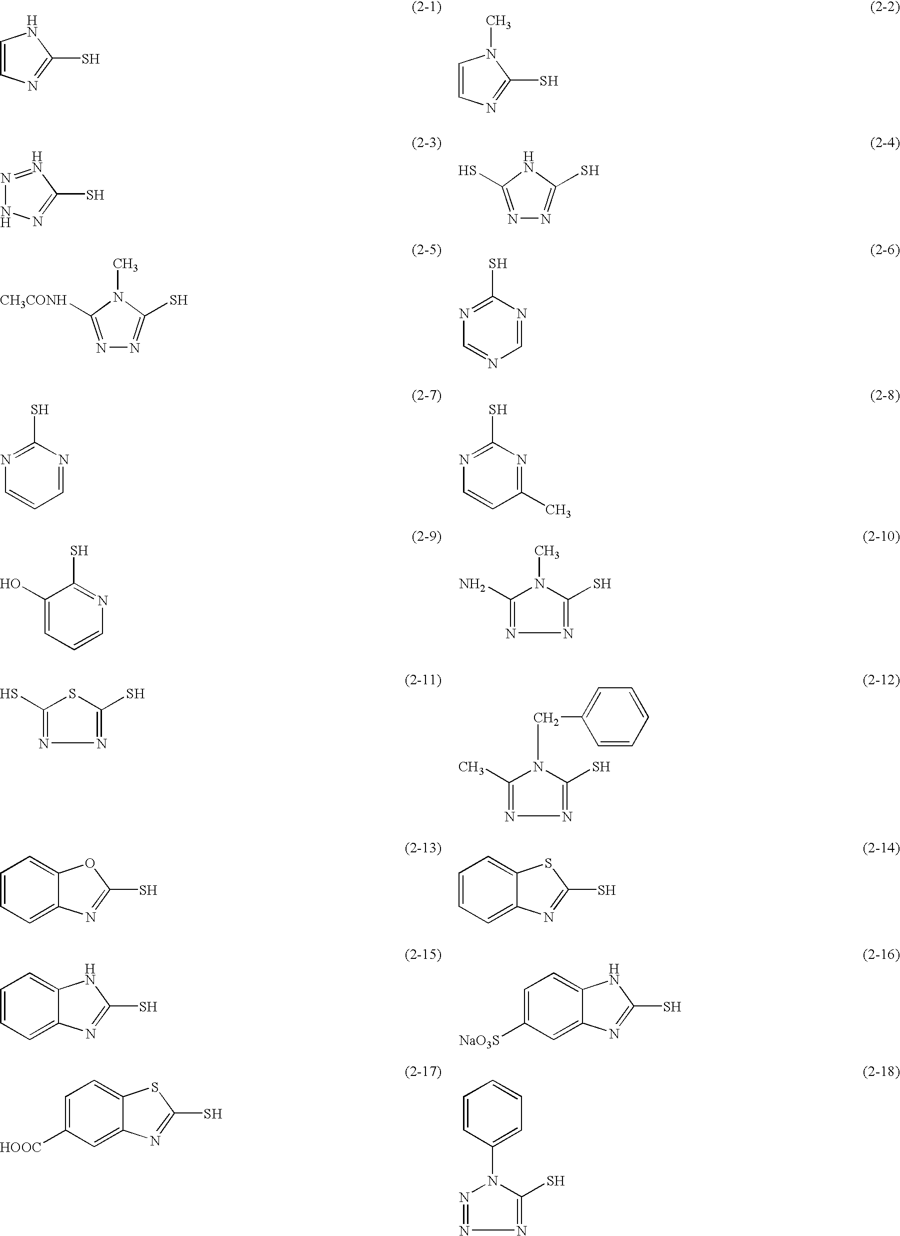

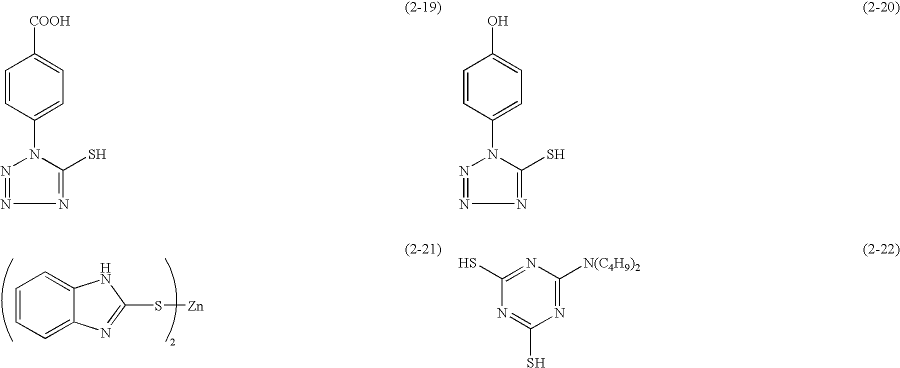

The added amount of the sulfur-containing compound to the porous ink accepting porous layer is preferably from 0.01 to 3.0 g per m² of the ink-jet recording sheet, even though there is no specific limitation of the added amount. When the amount is no more than 3 g, blocking of pores in the porous ink accepting porous layer by such compounds is inhibited so as to maintain the high ink absorbing ability. When the amount is not less than 0.01 g, the effects of the invention are sufficiently enhanced. From such a viewpoint, the compound is preferably used within the range of from 0.1 to 2 g per m² of the ink-jet recording sheet.

(C) Phenol Compounds

As the phenol compound, those described in Japanese Patent O.P.I. Publications 2000-233655,1-95091, 57-74192, 57-87989, 64-36480, and 1-18684 can be used. As preferable phenol compounds, hindered phenol compounds in which each of the molecules of which at least one of the ortho-sites of the hydroxyl group is substituted by a tertiary alkyl group, and hydroquinone diether compounds are cited. Concretely, the followings are usable: Sumilizer BHT, Sumilizer MDP-S, Sumilizer GM, and Sumilizer BBM-S, each produced by Sumitomo Kagaku Kogyo Co., Ltd.; Irganox 1076, Irganox 565, Irganox 1520, and Irganox 245, each produced by Ciba Specialty Chemicals Co., Ltd.; Adecastarb AO-80 and Adecastarb AO-23, each produced by Asahi Denka Kogyo Co., Ltd.; and 2,5-di(t)pentylhydroquinone-1,4-dioctyl ether.

Hindered compounds are exemplified.

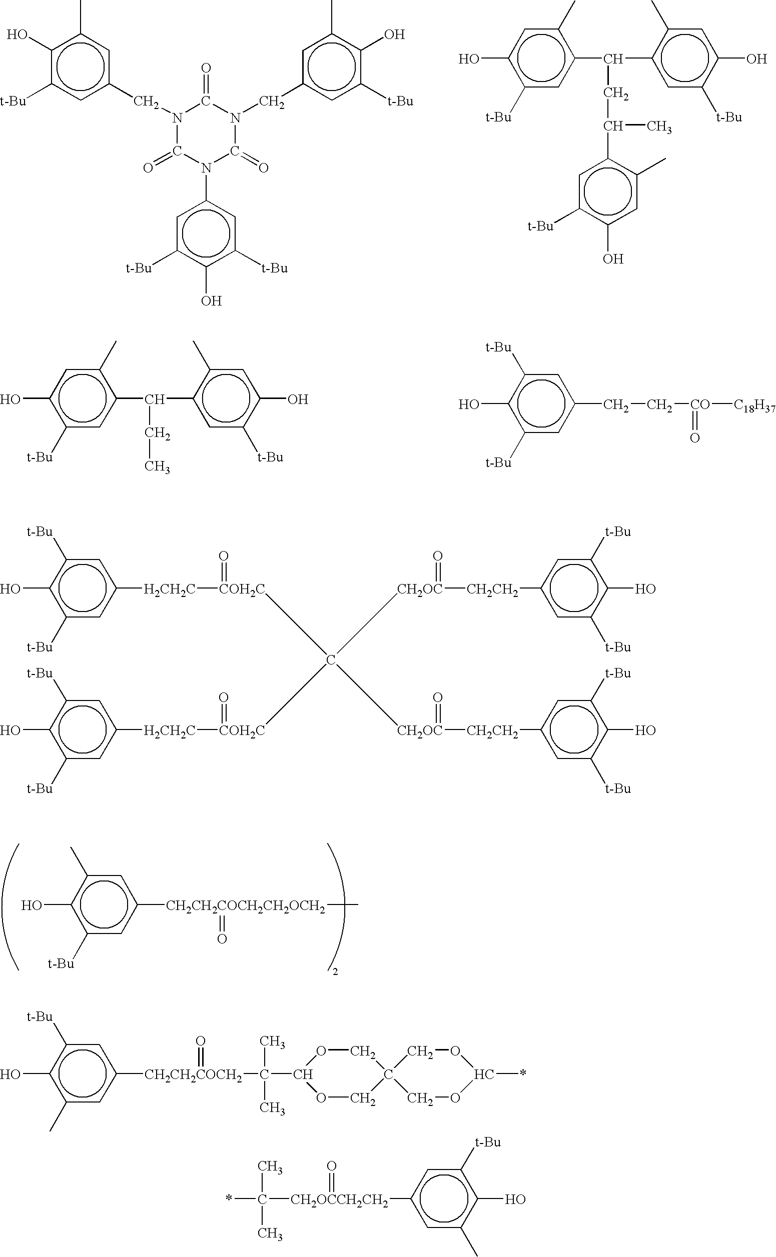

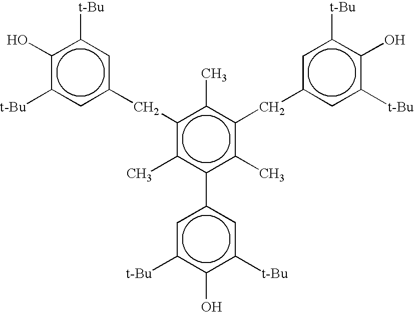

The added amount of the phenol compound to the porous ink accepting porous layer is preferably from 0.01 to 3.0 g per m² of the ink-jet recording sheet, even though the added amount is not specifically limited. When the amount is not more than 3 g, blocking of the space in the porous ink accepting porous layer by such compound is inhibited so as to maintain high ink absorbing ability. When the amount is not less than 0.01 g, the effects of the invention are sufficiently enhanced. From such viewpoint, the compound is preferably used within the range of from 0.1 to 2.0 g per m² of the ink-jet recording sheet.

(D) Polyvalent Metal Salt

The polyvalent metal salt is a salt of di- or more-valent metal, but a salt of di- through tetra-valent metals is preferred. For example, ones described in Japanese Patent O.P.I. Publications 7-149037, 61-43593, 55-53591, 56-86789, 58-94491, 59-155088, 59-96988, 60-46288, 60-67190, 60-189480, 61-10484, 61-57379, 8-25794, 4-7189, 8-118788, 9-1769995, 11-321099, 10-226153, 2001-130126, 2001-138622, 2001-238340, 2001-334742 and 2002-103786 may be used as a polyvalent metal salt. Preferable metal salts are water-soluble salts of cesium, magnesium, aluminum, and zirconium. Particularly preferable metal salts are zirconium salts, zirconium chloride, zirconium nitrate, zirconium acetate, and zirconium tetrachloride.

The added amount of the polyvalent metal salt to the porous ink accepting porous layer is within the range of approximately from 0.1 to 10.0 millimoles per m² of the ink-jet recording sheet. When the added amount is less than 0.1 millimoles, the desired effect of the salt is inadequate, and when the amount exceeds 10 millimoles, coagulation of the dye is accelerated and bronzing of the surface tens to occur. Particularly preferred added amount is from 0.2 to 2.0 millimoles per m² of the ink-jet recording sheet.

As the support to be used in the invention, known supports usually used for ink-jet recording sheet are commonly usable. Supports to be used for the ink-jet recording sheet can be roughly classified into supports, each of which is ink absorbable itself such as paper and that having an ink accepting porous layer thereon. Prints exhbiting high quality feeling can not be obtained by the former since high image density cannot be obtained and considerable wrinkles occur because the ink is directly absorbed into the support.

In contrast, an ink-jet print image with a high quality feel can be obtained by ink-jet recording sheets composed of an ink non-absorbable support and an ink accepting porous layer provided thereon since such sheets do not have the foregoing drawbacks. Accordingly, the preferable support is a water non-absorbable support.

For example, a transparent or opaque film made from polyester resin, diacetate resin, triacetate resin, polyolefin resin, acryl resin, polycarbonate resin, polyvinyl chloride resin, polyimide resin, cellophane or celluloid, and resin coated paper so-called RC paper, which is paper covered with a polyolefin resin layer on both side thereof, are usable.

For the purpose of enhancing the adhesion between said various supports and the ink receiving layer, it is preferable that prior to coating said ink receiving layer, said supports are subjected to a corona discharge treatment, as well as a subbing treatment. Further, the ink-jet recording sheets of the present invention are not necessary to be white and may be tinted.

Preferable examples of the supports are transparent polyester film, opaque polyester film, opaque polyolefin resin film and paper support laminated with polyolefin resin on both sides. It is particularly preferable that employed as the ink-jet recording sheets of the present invention be polyethylene laminated paper supports. Said polyethylene laminated paper supports will now be described.

Base paper, employed in said paper supports, are made employing wood pulp as the main raw material, if necessary, together with synthetic pulp such as polypropylene and synthetic fiber such as nylon and polyester. Employed as said wood pulp may be any of LBKB, LBSP, NBKP, NBSP, LDP, NDP, LUKP, or NUKP. It is preferable that LBKP, NBSP, LBSP, NDP, and LDP, which are comprised of shorter fiber, are employed in a greater amount. However, the ratio of LBSP and/or LDP is preferably from 10 to 70 percent by weight.

Preferably employed as said pulp is chemical pulp (sulfate pulp and sulfite pulp). Further, also useful is pulp which has been subjected to a bleach treatment to increase its whiteness.

Into said base paper suitably incorporated may be sizing agents such as higher fatty acids and alkylketene diners; white pigments such as calcium carbonate, talc, and titanium oxide; paper strength enhancing agents such as starch, polyacrylamide, and polyvinyl alcohol; optical brightening agent; moisture maintaining agents such as polyethylene glycols; dispersing agents; and softeners such as quaternary ammonium salts.

The degree of water freeness of pulp employed for paper making is preferably from 200 to 500 ml under CSF Specification. Further, the sum of weight percent of 24-mesh residue and weight percent of 42-mesh calculated portion regarding the fiber length after beating, specified in JIS-P-8207, is preferably between 30 and 70 percent. Further, the weight percent of 4-mesh residue is preferably 20 percent by weight or less.

The weight of said base paper is preferably from 30 to 250 g/m², and is most preferably from 50 to 200 g/m². The thickness of said base paper is preferably from 40 to 250 μm.

During the paper making stage or after paper making, said base paper may be subjected to a calendering treatment to result in excellent smoothness. The density of said base paper is generally from 0.7 to 1.2 g/m³ (JIS-P-8118). Further, the stiffness of said base paper is preferably from 20 to 200 g under the conditions specified in JIS-P-8143. Surface sizing agents may be applied onto the base paper surface. Employed as said surface sizing agents may be the same as those above, capable of being incorporated into said base paper. The pH of said base paper, when determined employing a hot water extraction method specified in JIS-P-8113, is preferably from 5 to 9.

Polyethylene, which is employed to laminate both surfaces of said base paper, is mainly comprised of low density polyethylene (LDPE) and/or high density polyethylene (HDPE). However, other LLDPE or polypropylene may be partially employed.

Specifically, as is generally done with photographic paper, the polyethylene layer located on the ink receiving layer side is preferably constituted employing polyethylene into which rutile or anatase type titanium oxide is incorporated so that opacity as well as whiteness is improved. The content ratio of said titanium oxide is generally from 1 to 20 percent by weight with respect to polyethylene, and is more preferably from 2 to 15 percent by weight.

It is possible to employ said polyethylene coated paper as glossy paper. Further, in the present invention, it is possible to employ polyethylene coated paper with a matt or silk surface, as obtained in the conventional photographic paper, by carrying out an embossing treatment during extrusion coating of polyethylene onto said base paper.

The used amount of polyethylene on both surfaces of said paper is selected so as to optimize the layer thickness of a water based coating composition as well as curling at low and high humidity after providing a back layer. The thickness of the polyethylene layer on the side onto which the water based coating composition in accordance with the present invention is applied, is preferably in the range of 20 to 40 μm, while the thickness of the polyethylene layer on the opposite side is preferably in the range of 10 to 30 μm.

Further, it is preferable that said polyethylene coated substrate exhibits the characteristics described below.

(1) Tensile strength is preferably from 20 to 300 N in the longitudinal direction and from 10 to 200 N in the lateral direction, in terms of the strength specified in JIS P 8113.

(2) Tear strength is preferably from 0.1 to 2 N in the longitudinal direction and from 0.2 to 2 N in the lateral direction in terms of the tear strength specified in JIS P 8116.

(3) Compression elasticity is no less than 1,030 N/cm².

(4) Bekk surface smoothness is preferably at least 500 seconds under conditions specified in JIS P 8119, however so-called embossed papers may exhibit less than that.

(5) Bekk rear surface smoothness is preferably from 100 to 800 seconds under conditions specified in JIS P 8119.

(6) Opacity is preferably no more than 20 percent and is most preferably no more than 15 percent in terms of the transmittance of light in the visible region, which is determined under conditions of parallel light incidence/diffused light transmission.

(7) Whiteness is preferably at least 90 percent in terms of Hunter's brightness specified in JIS P 8123. Further, when measurement is carried out utilizing JIS Z 8722 (non-fluorescence) and JIS Z 8717 (incorporation of fluorescent agents) and the color is represented utilizing the color specification specified in JIS Z 8730, it is preferable that L*=90 to 98, a*=−5 to +5, and b*=−10 to +5.

For the purpose of enhancing adhesion to the ink receptive layer, a subbing layer is preferably provided on the ink receptive layer side of said substrate. Binders for said subbing layer are preferably hydrophilic polymers such as gelatin, polyvinyl alcohols, and latex polymers having a Tg of −30 to 60° C. Said binders are employed in an amount of 0.001 to 2 g per m² of the recording sheet. For the purpose of minimizing static charge, a small amount of antistatic agent such as cationic polymers, conventionally known in the art, may be incorporated.

For the purpose of improving slipping properties as well as electrification characteristics, a back layer may be provided on the surface opposite the ink receptive layer of said substrate. Binders for said back layer are preferably hydrophilic polymers such as gelatin, polyvinyl alcohols, and latex polymers having a Tg of −30 to 60° C. Further, also incorporated may be antistatic agents such as cationic polymers, various types of surface active agents, and in addition, about 0.5 to about 20 μm matting agents. The thickness of said backing layer is from about 0.1 to about 1 μm. However, when said backing layer is provided to minimize curling, its thickness is to be from about 1 to about 20 μm. Further, said backing layer may be comprised of at least two layers.

When said subbing layer, as well as said back layer, is coated, surface treatments such as a corona treatment or a plasma treatment applied onto the substrate surface are preferably employed in combination.

Various types of additives can be incorporated into the water-soluble coating composition which forms said porous layer. Listed as said additives are, for example, cationic mordants, cross-linking agents, surface active agents (being cationic, nonionic, anionic, or amphoteric), background color modifiers, optical brighteners, antiseptics, viscosity modifiers, low-boiling-point organic solvents, high-boiling-point organic solvents, latex emulsions, anti-discoloring agents, UV absorbers, multivalent metallic compounds, (being water-soluble or water-insoluble), matting agents, and silicone oil. Of these, cationic mordants are preferred to enhance waterfastness as well as moisture resistance.

Employed as said cationic mordants are polymer mordants having a primary, secondary, or tertiary amino group or a quaternary ammonium salt group. Of these, polymer mordants having a quaternary ammonium salt group are preferred, which result in minimal discoloration as well as minimal degradation of lightfastness during storage, and exhibit sufficiently high mordant capability toward dyes. Said preferred mordants are prepared as either homopolymers of monomers having said quaternary ammonium salt group or copolymers, and condensation polymers of said monomers with other monomers.

Further, it is particularly preferred to incorporate cross-linking agents of hydrophilic binders. The cross-linking agent is able to be comprised in the porous layer or to overcoat the dried porous layer. By employing said cross-linking agents, the waterresistance of the porous layer is enhanced, and in addition, the ink absorbing rate is also enhanced during ink jet recording due to the fact that the swelling of said hydrophilic binders is retarded.

Cross-linking agents may be employed, which include inorganic cross-linking agents (for example, chromium compounds, aluminum compounds, zirconium compounds, and boric acids), and organic cross-linking agents (for example, epoxy based cross-linking agents, isocyanate based cross-linking agents, aldehyde based cross-linking agents, N-methylol based cross-linking agents, acryloyl based cross-linking agents, vinyl sulfone based cross-linking agents, active halogen based cross-linking agents, carbodiimide based cross-linking agents, and ethyleneimine based cross-linking agents). The content ratio of said cross-linking agents is commonly from about 1 to 50 percent by weight with respect to the hydrophilic binder, and is preferably from 2 to 40 percent by weight.

When said hydrophilic binders are comprised of polyvinyl alcohols and fine articles are comprised of silica, particularly preferred as cross-linking agents are inorganic cross-linking agents containing element of 3A, 3B, 4A or 4B in Periodic Table such as boric acids and zirconium compounds, as well as epoxy based cross-linking agents.

The ink jet recording medium is produced employing a method in which constitution layers comprising an ink absorptive layer are individually or simultaneously applied onto a support, employing a method which is appropriately selected from methods known in the art, and subsequently dried. Preferably employed coating methods include, for example, a roll coating method, a rod bar coating method, an air knife coating method, a spray coating method, a curtain coating method, a slide bead coating method employing a hopper, described in U.S. Pat. Nos. 2,761,419 and 2,761,791, or an extrusion coating method.

The viscosity of each of the coating liquids during simultaneously multi-layer coating is preferably from 5 to 100 mPa·s, more preferably from 10 to 50 mPa·s, for a slide bead coating method, and preferably from 5 to 1200 mPa·s, more preferably from 25 to 500 mPa·s, for a curtain coating method.

The viscosity of the coating liquid at 15° C. is preferably not less than 100 mPa·s, more preferably from 100 to 30,000 mPa·s, further preferably from 3,000 to 30,000 mPa·s, and most preferably 10,000 to 30,000 mPa·s.

Next, the coated layer is irradiated by ionizing radiation such as ultraviolet rays by a mercury lump or a metal halide lump. The crosslinking reaction of the polymer compound, preferably the crosslinking reaction between the side chains of the polymer compound, is progressed by the irradiation by the ionizing radiation so that the viscoelasticity of the coated layer is raised and gelatinized. Thus a uniform coated layer can be formed. The coated layer is dried after irradiation by the ionizing radiation, and an ink-jet recording sheet can be obtained, which is composed of a support and a uniform porous ink accepting layer principally containing the hydrophilic binder and the micro particles and has pores provided on the support.

In the invention, it is preferable that the coated layer is dried after the irradiation by the ionizing radiation to evaporate the aqueous solvent contained in the coated layer. It is preferred that the coated layer is irradiated by the ionizing radiation in the state of that the layer contains the aqueous solvent, more preferably the radiation is applied just after the coating, even though a part or major part of the solvent may have been evaporated at the time for irradiating the ionizing radiation. As above-mentioned, the ink-jet recording sheet having the uniform porous ink accepting layer can be obtained by drying at a high temperature without necessity to maintain at low temperature and to add of any crosslinking agent, thus high production efficiency can be attained and unevenness of the layer caused by blowing can be inhibited.

It is more preferable to irradiate the ionizing radiation when the ratio of water to the solid components in the coated layer is 100% or more by weight. Moreover, it is preferable to irradiate the ionizing radiation when the ratio of water to the solid components in the coated layer is less than 100% by weight.

The irradiation of the ionizing radiation is preferably performed so that the elasticity and the viscosity of the coated layer are raised by 1.5 times or more after the irradiation. It is more preferable that the elasticity and the viscosity of the coated layer are raised by 3 times or more after the irradiation. When the recording sheet is produced by such the method, strong gel structure can be formed so that the pores can be efficiently maintained and formed withstanding the drying stress at the drying period. Accordingly, it is not necessary to maintain the coated layer at a low temperature for setting the layer and to add any crosslinking agent to the porous ink accepting layer. Thus the layer can be rapidly dried at a high temperature and high production efficiency can be attained, furthermore, the unevenness of the layer caused by blowing can be inhibited.

The viscosity and the elasticity are values measured by a viscoelasticity measuring apparatus. For example, the viscoelasticity is determined by analysis of swing cycle of a rigid pendulum with respect to the coated layer measured by a rigid pendulum viscoelasticity measuring apparatus RPT-3000W, manufactured by A & D Co., Ltd. The reciprocal of the cycle of the pendulum swing represents the elasticity and the logarithmic attenuation ratio of the swing cycle represents the viscosity.

It is preferable from the viewpoint of pore formation to remove the solvent as rapid as possible after the formation of the gel structure.

According to the above-mentioned, it is preferred that the irradiation of the ionizing radiation is performed after the coating of the coating liquid, so as to set to gel the coated liquid by the crosslinking between the side chains of the polymer compound contained in the coating liquid and to form the suitability of the coated layer to the drying blow. It is preferable to reapply the irradiation just before the moisture content of the coated layer becomes to 100% to strengthen the gel structure or/and to rapidly raise the drying temperature so as to remove the contained solvent as rapid as possible after the irradiation. The moisture content is the ratio of the amount of water to that of the solid components in the coating liquid, which is determined by weight.

Examples of ionizing radiation include electron beams, ultraviolet radiation, α-rays, β-rays, γ-rays, and X-rays. Preferably employed are electron beams and ultraviolet radiation, which do not have the large influence on a human body and are easily handled and thus widely employed in industry.

When electron beams are employed, the exposure amount of the aforesaid electron beam is preferably controlled to be in the range of 0.1-20 Mrad. An exposure amount of not less than 0.1 Mrad does not result in sufficient exposure effects. An exposure amount of at not more than 20 Mrad is not preferred because it is able to avoid deteriorating deteriorate supports, especially paper and certain type of plastics. Accepted as electron beam exposure systems are, for example, a scanning system, a curtain beam system, and a broad beam system. Appropriate acceleration voltage during electron beam exposure is 100-300 kV. Incidentally, the aforesaid electron beam exposure system exhibits advantages such that, compared to the ultraviolet radiation exposure, higher productivity can be achieved, problems such as unpleasant odor and coloration due to the addition of sensitizers do not occur, and further, uniform crosslinking structures are easily achieved.

The aforesaid hydrophilic polymer compounds are sensitive to, for example, ultraviolet radiation without adding the sensitizers described below and are capable of readily undergoing a crosslinking reaction. Employed as radiation sources of the ultraviolet radiation are UV lamps (e.g., low pressure, medium pressure, and high pressure mercury lamps having an operating pressure of 0.5-1 MPa), xenon lamps, tungsten lamps, and halogen lamps. The intensity of the exposed ultraviolet radiation is preferably about 5,000- about 8,000 μW/cm². Energy requirement for crosslinking through the side chains is commonly in the range of 0.02-20 kJ/cm², but may be less than 0.02 kJ/cm², depending on the polymer to be crosslinked by irradiation.

Further, when ultrviolet radiation is employed, sensitizers may be incorporated in coating compositions. For example, sensitizers such as thioxanthone, benzoin, benzoin alkyl ether xanthone, dimethylxanthone, benzophenone, and 1,1-dichloroacetophenone may be incorporated individually or in combinations of at least two types.

The used amount thereof is customarily controlled to be in the range of 0.2-10 percent by weight with respect to the ionizing radiation crosslinkable type polymer compound in the coating composition, and preferably in the range of 0.5-5 percent by weight when sensitizers are employed.

In the invention, the crosslinking reaction of polymer compound capable of crosslinking by irradiation via ionizing radiation is accelerated and the fluidity of the coated layer is inhibited when the coated layer is irradiated by the ionizing radiation in the presence of a hydrophilic solvent. Thus a uniformly coated layer can be formed. Concretely, the coated layer is dried after irradiation via ionizing radiation by evaporating the aqueous solvent principally composed of water. However, a minor or major part of the aqueous solvent may be evaporated in the course of the irradiation via ionizing radiation.

A good layer surface can be obtained by the drying at relatively low temperature since the occurrence of cracks can be inhibited, which is caused by breaking of the hydrogen bond between the binder and the fine particle by molecular movement according to the temperature raising of the coated layer. In such the case, the temperature of the coated layer during the drying is preferably not more than 50° C., and is more preferably not less than 40° C.

The polymer compound crosslinked via the irradiation of the ionizing radiation has higher resistively to the temperature rising of the coated layer than the weak bonding such, as hydrogen bond. Accordingly, the dying temperature can be raised after the irradiation of the ionizing radiation and the high speed coating can be easily performed.

After the irradiation of the ionizing radiation, the temperature of the coated layer during the drying is preferably from 50° C. to 80° C., and is more preferably from 60° C. to 70° C.

In the invention, the drying speed can be raised and the high product efficiency can be obtained since the drying temperature can be raised after the irradiation of the ionizing radiation by 10° C. or more compared with that before the irradiation.

It is preferred that the recording paper according to the invention is preferably stored for 1 day to one month, more preferably for 1 to 3 days from the viewpoint of the cost, after wound in the rolled state or cut into a roll or sheet state.

The forming method of the porous ink accepting layer according to the invention is described below.

The porous ink accepting layer according to the invention contains at least one selected from the group consisting of (A) a nitrogen-containing compound, (B) a sulfur-containing compound, (C) a phenol compound, and (D) a poly-valent metal salt. There are three ways for adding such the compounds, hereinafter referred to as the compound according to the invention as long as any specific description is not attached, into the porous ink accepting layer.

The first method:

The compound according to the invention is added to the aqueous dispersion containing the polymer compound capable of forming crosslinks by the irradiation of the ionizing radiation according to the invention and the micro particles which are the principal constituting components of the porous ink accepting layer, and the dispersion is coated on the support and irradiated by the ionizing radiation and dried to prepare the porous ink accepting layer according to the invention.

The second method:

An aqueous dispersion containing the polymer compound capable of forming crosslinks by the irradiation of the ionizing radiation according to the invention and the micro particles, which are the principal constituting components of the porous ink accepting layer, is coated on the support and subjected to the irradiation by the ionizing radiation to form a coated layer. Then a solution containing the compound according to the invention is provided onto the coated layer on the same coating line of the coated layer in the course of drying of the coated layer after the falling-rate drying zone and after the moisture content of the coated layer is become less than the volume of pores in the porous ink accepting layer to form the porous ink accepting layer according to the invention. Hereinafter, this second method is referred to as the online over coating method as long as any specific description is not attached.

The third method:

An aqueous dispersion containing the polymer compound capable of forming crosslinks by the irradiation of the ionizing radiation according to the invention and the micro particles, which are the principal constituting components of the porous ink accepting layer, is coated on the support, subjected to the irradiation by the ionizing radiation to form a coated layer and dried. Then a solution containing the compound according to the invention is provided onto the dried porous layer. Hereinafter, the third method is referred to as the over coating method as long as any specific description is not attached.

A polymer compound capable of forming no crosslinking by the irradiation of the ionizing radiation and another additive may be contained according to necessity in the aqueous dispersion containing the polymer compound capable of crosslinking and the micro particles as the principal components.

Moreover, any optional additive may be added according to necessity into the solution containing the compound according to the invention. This method can be applied to various compounds such as a compound which is easily destroyed by the irradiation of the ionizing radiation, a compound which tends to cause cracks at the drying process, a compound causes coagulation when the compound is added to the aqueous dispersion, a compound which considerably raises or lowers the viscosity of the coating liquid, and a compound of which effects are difficultly obtained by reaction with water or another additive is used even if these compounds can be added to the aqueous dispersion containing the polymer compound capable of crosslinking by the irradiation of ionizing radiation according to the invention and the micro particles as the principal constituting components.

The solution of the compound according to the invention is preferably contains a surfactant. As the surfactant, anionic, cationic, amphoteric and nonionic surfactants are usable. The two or more kinds of the surfactant may be used in combination. The adding amount of the surfactant is approximately from 0.01 to 50 mg per square meter of the ink-jet recording sheet. Speckle like unevenness difficultly occur when the amount is less than 50 mg. Various additives may be added other than the surfactant. Examples of the additive include a dye for controlling the tone of the white background, a water soluble polymer and a plasticizer. The additives may be used solely or in combination.

As the solvent of the solution containing the compound according to the invention, water or a mixture of water and a water-miscible organic solvent is preferable and water is more preferable. A mixture of water and a water-miscible low-boiling organic solvent such as methanol, ethanol, iso-propanol, n-propanol, acetone, and methyl ethyl ketone is also preferable solvent. When water and the water-miscible organic solvent are used in combination, the content of water is preferably not less than 50% by weight. The water-miscible organic solvent is an organic solvent having water solubility of not less than 10% at a room temperature and a boiling point not more than 120° C. The surface tension of the solution containing the compound according to the invention is preferably from 200 to 600 μN/cm at a room temperature from the viewpoint for obtaining a uniform coated layer. The viscosity of the solution containing the compound according to the invention is preferably not more than 100 mPa·s. When the viscosity exceeds 100 mPa·s, the solution tends to cause unevenness on the coated layer or to reduce the ink absorbing capacity since the permeability of the solution into the coated layer is lowered. The preferable viscosity is from 0.5 to 20 mPa·s.

In the online over coating method and the over coating method, examples of the method for providing the solution containing the compound according to the invention onto the coated layer or the porous layer include (a) a method by coating, (b) a method by spraying and (c) a method by immersing the coated layer or the porous layer into the solution containing the compound according to the invention. From the viewpoint of production, the method (a) by coating is preferred. As the method for forming the porous ink accepting layer according to the invention, the second method or the online over coating method is particularly preferred. The second method is described below.

The volume of the void was determined by the amount of liquid transfer during the contact time of 2 seconds according to the test method of liquid absorption of paper and cardboard (Bristow method) defined in J. TAPPI 51.

In the invention, the period after that the moisture content of the coated layer is become less than the volume of the pores after dried is generally corresponded to after the falling-rate drying zone. The falling-rate drying is a phenomenon which occurs when the evaporation of moisture from the surface is larger than the moving of the moisture in the coated layer. Generally the pores are formed after that the drying enters into the falling-rate drying zone and moisture is further evaporated. If the solution is coated in the period in which the drying is insufficient and the moisture content of the coated layer exceeds the pores volume, a coagulum is formed on the surface and unevenness tends to be formed on the glossiness or various ink-jet recording properties since the solution is flowed in the course of drying. Moreover, it is preferable that the solution is provide before winding the coated support in a rolled state since the condition of the hydrophilic binder is varied during the standing period after the winding and variation of the product quality occurs when the coated support is dried and winded once and then the solution is coated, even if the moisture content of the coated layer is less than the volume of the pores.

Preferable time for providing the solution containing the compound according to the invention onto the coated layer is the time when the coated layer is dried so that the total amount of moisture contained in the coated layer and the provided solution is made less than the volume of the pores after the dried. The most preferred condition is that the moisture content of the coated layer is substantially balanced with the atmospheric air.

The coating amount of the solution containing the compound according to the invention is changed depending on the drying period of the coated layer and is decided so that the total of the amount of moisture contained in the coated layer and that of the solution is smaller than the volume of the pores. The volume the pores in the porous ink accepting layer after dried is synonymous with the volume of the pores at the finishing point of drying. The volume of pores in the porous ink accepting layer is not varied after the finishing point of drying.

When the solution is provided by the coating method under the most preferable condition in which the moisture content in the coated layer is dried so as to balance with atmospheric air, the total of the amount of moisture contained in the porous ink accepting layer and that of the solution containing the compound according to the invention is not more than 1.5 times of the volume of the pores in the porous ink accepting layer at the finishing point of drying. More preferably the ratio is in the range of from 0.05 to 1.5 times of the volume of the pores in the porous ink accepting layer. When the ratio is less than 0.05 times, the coating of the solution containing the compound according to the invention tends to be uneven. When the ratio exceeds 1.5 times, the solution is easily flowed and coating unevenness tends to occur. The preferable supplying amount of the solution containing the compound according to the invention is from 0.1 to 1.2 times of the volume of the pores. The “moisture” of the moisture content means the liquid, water or a mixture thereof, capable of evaporating by the drying of the coated layer.

The solution containing the compound according to the invention may be coated at once or separately twice or more. In such the case, the total of the amount of moisture contained in the coated layer and the amount of the solution containing the compound according to the invention is controlled in each of the coating steps so that the total amount is not more than the volume of the pores.

### EXAMPLES

The invention is described below referring Examples. In the examples, “%” is “% by weight” as long as no specific description is attached.

Preparation of Ink-Jet Recording Sheet

Preparation of Ink-Jet Recording Sheet 1 (Comparative Sample)

To 100 kg of 25% dispersion of gas phase method silica (Aerosil 300 produced by Nihon Aerosil Co., Ltd., averaging 7 nm diameter of primary particles) which has a pH of 4.0 and contains 1% of ethanol, and is preliminary uniformly dispersed, 50 kg of a 10% aqueous solution of photo-crosslinkable polyvinyl alcohol, in which a stilbazolium group is introduced, (SPP-SHR produced by Toyo Gosei Kogyo Co., Ltd., with the polymerization degree of the main chain PVA being 2300, and the saponification degree 88%) was added while stirring, and Surfactant S-1 was subsequently added.

Then the mixture was dispersed by a high pressure homogenizer at 3000N/cm² and filtered through Ball filter, TCP-30 having a filtering accuracy of 30 μm, manufactured by Advantec Toyo Kaisha, Ltd., and made up to 200 liters with purified water to obtain Coating Liquid 1.

The above Coating Liquid 1 was coated on a paper support covered with polyethylene containing 6% of anatase type titanium oxide on both sides so that the wet layer thickness was 170 μm.

After the coating, the coated layer was irradiated by UV rays at an energy amount of 2 kJ/cm². Then the surface of the ink accepting porous layer was air dried at 80° C. to obtain Ink-jet Recording Sheet 1.

Surfactant S-1

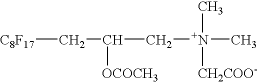

Preparation of Ink-Jet Recording Sheet 2 (Inventive Sample)

Ink-jet Recording Sheet 2 was prepared in the same manner as Ink-jet Recording Sheet 1 except that added was 10 kg of a 10% aqueous solution of polyallylamine hydrochloride PAA-HCL-10L, produced by Nitto Boseki Co., Ltd.

Preparation of Ink-Jet Recording Sheet 3 (Inventive Sample)

Ink-jet Recording Sheet 2 was prepared in the same manner as Ink-jet Recording Sheet 1 except that added was 5 kg of a 10% aqueous solution of sulfur-containing compound 1-2.

Preparation of Ink-Jet Recording Sheet 4 (Inventive Sample)

Ink-jet Recording Sheet 4 was prepared in the same manner as Ink-jet Recording Sheet 1 except that added was 10 kg of a 5% aqueous solution of hindered amine compound Adecastab LX-332 produced by Asahi Denka Kogyo Co., Ltd.

Preparation of Ink-Jet Recording Sheet 5 (Inventive Sample)

Ink-jet Recording Sheet 5 was prepared in the same manner as Ink-jet Recording Sheet 1 except that added was 9 kg of a 5% aqueous solution of hindered phenol compound Adecastab LX-802 produced by Asahi Denka Kogyo Co., Ltd.

Preparation of Ink-Jet Recording Sheet 6 (Inventive Sample)

Ink-jet Recording Sheet 6 was prepared in the same manner as Ink-jet Recording Sheet 1 except that added was 1.5 kg of a 10% aqueous solution of zirconium acetate Zircosol ZA produced by Asahi Denka Kogyo Co., Ltd.

Preparation of Ink-Jet Recording Sheet 7 (Comparative Sample)

Ink-jet Recording Sheet 7 was prepared in the same manner as Ink-jet Recording Sheet 2 except that the photo-crosslinkable polyvinyl alcohol derivative was replaced by a 10% aqueous solution of polyvinyl alcohol, PVA235, produced of Kuraray Co., Ltd.

Preparation of Ink-Jet Recording Sheet 8 (Inventive Sample)

Ink-jet Recording Sheet 8 was prepared in the same manner as Ink-jet Recording Sheet 3 except that 10 kg of the 50 kg of 10% aqueous solution of the photo-crosslinkable polyvinyl alcohol derivative was replaced by a 10% solution of polyvinyl alcohol, PVA235, produced by Kuraray CO., Ltd.

Preparation of Ink-Jet Recording Sheet 9 (Comparative Sample)

Ink-jet Recording Sheet 9 was prepared in the same manner as Ink-jet Recording Sheet 7 except that 500 g of boric acid and 400 g of borax were added.

Preparation of Ink-Jet Recording Sheet 10 (Inventive Sample)

Ink-jet Recording Sheet 10 was prepared in the same manner as Ink-jet Recording Sheet 2 except that 80 kg of a 10% aqueous solution of the photo-crosslinkable polyvinyl alcohol derivative was added.

Preparation of Ink-Jet Recording Sheet 11 (Inventive Sample)

Ink-jet Recording Sheet 11 was prepared in the same manner as Ink-jet Recording Sheet 1 except that 10 kg of a 5% aqueous solution of triethanol amine, which is a nitrogen containing compound, was added.

Preparation of Ink-Jet Recording Sheet 12 (Inventive Sample)

Ink-jet Recording Sheet 12 was prepared in the same manner as Ink-jet Recording Sheet 1 except that 10 kg of a 5% aqueous solution of Hydroxylamine compound A was added.

Preparation of Ink-Jet Recording Sheet 13 (Inventive Sample)

Ink-jet Recording Sheet 13 was prepared in the same manner as Ink-jet Recording Sheet 1 except that 10 kg of a 10% aqueous solution of polyvinyl amine (average molecular weight of 70,000) was added in place of 10 kg of a 10% aqueous solution of polyallylamine hydrochloride PAA-HCL-10L.

Hydroxylamine Compound A

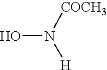

Hydroquinone Diether Compound A

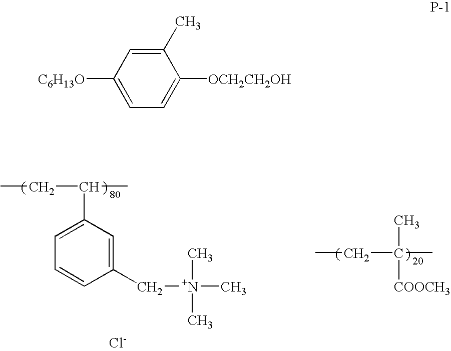

Evaluation of characteristics of the ink-jet recording sheet

Each of the above-prepared ink-jet recording sheets was subjected to evaluation of photo-fading, weather resistivity of the binder, cracking of the layer, fracturing of the layer caused by bending, and ink absorbability.

Evaluation on Photo-Fading

A solid cyan monochromatic image was printed on an ink-jet recording sheet for the evaluation and the printed image was stand for 3 months under ambient room light. The photo fading was represented by the remaining ratio of the optical density of the image after standing to that before standing. A larger value corresponds to a high remaining ratio and good photo-fading resistive property.

A: 0.95 or more

B: 0.85- less than 0.95

C: 0.75- less than 0.85

D: less than 0.75

Evaluation of Weather Resistivity

The image was allowed to stand just after printing for 12 hours at 40° C. and a high relative humidity of 70%, and the condition of the surface was visually observed. Alternatively, the printed image was allowed to stand for 12 hours in a Xe Fade-o-Meter (70,000 lux) after which the printed surface was visually observed.

A: No cracking was observed on the printed surface.

B: Slight racking was observed on the printed surface.

C: Cracking was apparent on the printed surface.

Evaluation of Layer Cracking

The number of cracks each having a length of at least 0.2 mm per 10×10 cm of the ink-jet recording sheet was counted and classified into the four following ranks.

A: Not more than 3 (No problem for practical use)

B: From 4 to 10 (No problem for practical use)

C: From 11 to 19 (Problems were raised for practical use)

D: 20 or more (Problems were raised for practical use)

Evaluation of Fracturing Caused by Bending

The ink-jet recording sheet was conditioned for 3 hours at a temperature of 23° C. and a relative humidity of 10%, then the surface of the ink accepting porous layer was heated by 150° C. and immediately wound onto stainless steel rods each having a diameter of 10, 15 and 20 mm so that the surface of the ink accepting porous layer was to be out side. Then noted was the diameter of the rod on which fractures of the ink accepting porous layer was caused.

A: No fracture occur on the 10 mm rod (No problem for practical use)

B: Fractures occur on the 10 mm rod (No problem for practical use)

C: Fractures occur on the 15 mm rod (Problems were raised in practical use.)

D: Fractures occur on the 20 mm rod (Problems were raised in practical use.)

Evaluation on Ink Absorbability

A solid blue image was printed on each of the ink-jet recording sheets by Ink-jet Printer PM950C, manufactured by Seiko-Epson Co,. Ltd. The printed area was visually observed and evaluated according to the following norm.

No sample was classified as rank D in these examples.

A: No unevenness in the printed area was observed. (No problem for practical use)

B: Slight unevenness in the printed area was observed. (No problem for practical use)

C: Apparent unevenness in the printed area was observed. (Problems were raised for practical use)

D: Unevenness was observed in almost all the printed area. (Problems were raised for practical use)

Results of the evaluation are shown in Table 1.

TABLE 1

| | | Weather | | | | | |
|---|---|---|---|---|---|---|---|
| | | resistivity of | | | Fractures | | |
| | | binder | | | of the | | |
| | | Xe | | Cracking | layer | Ink | |
| Sample | Photo- | irradia- | High | of the | caused by | absorb- | |
| No. | fading | tion | humidity | layer | bending | ability | Remarks |
| 1 | C | B | B | C | C | A | Comp. |
| 2 | A | A | A | A | A | A | Inv. |
| 3 | B | A | A | B | A | A | Inv. |
| 4 | A | A | A | A | B | A | Inv. |
| 5 | B | A | A | A | B | A | Inv. |
| 6 | B | A | A | B | A | A | Inv. |
| 7 | D | C | C | D | D | C | Comp. |
| 8 | B | A | A | A | A | A | Inv. |
| 9 | C | B | B | C | C | A | Comp. |
| 10 | B | A | A | B | B | B | Inv. |
| 11 | B | A | A | A | A | A | Inv. |
| 12 | B | A | A | B | A | A | Inv. |
| 13 | B | A | A | A | A | A | Inv. |
| 14 | B | A | A | B | A | A | Inv. |
| 15 | B | A | A | A | B | B | Inv. |

Comp.; Comparative
Inv.; Inventive

In Table 1, “Sample No.” is the number of the ink-jet recording sheet. “Xe irradiation” shows the evaluation results after standing for 12 hours in an Xe Fade-o-Meter, and “High humidity” shows the evaluation results after standing for 12 hours under a relative humidity of 70%.

It can be seen from the results shown in Table 1 that the ink-jet recording sheets of the invention were excellent in resistance of photo-fading of color and caused no problem for practical use regarding all aspects including weather resistivity of the binder, cracking of the layer, the fracturing caused by bending of the layer, and the ink absorbability.

### Example 2

Preparation of Ink-Jet Recording Sheet

<Preparation of Ink-Jet Recording Sheet 202 (Inventive Sample)>

The foregoing Coating Liquid 1 was coated on the paper support in the same manner as in Ink-jet Recording Sheet 1 of Example 1. Then the coated support was passed through a cooling zone maintained at 5° C. spending 15 seconds so that the surface temperature of the coated layer was lowered by 13° C. The coated layer was subjected to irradiation of ultraviolet rays with energy amount of 2 kJ/cm² by a metal halide lamp during the passing through the cooling zone for 15 seconds to crosslink the photo-crosslinkable poly(vinyl alcohol) derivative having a stilbazolium group. Thereafter, the coated layer was dried by passing through the 1st through 8th zones while blowing air having the following temperature to the layer surface. Then an aqueous solution of triethanolamine was online over coated by a spray coater at the exit of the 8th zone so that the coated amount was the same as that in Ink-jet Recording Sheet 11. The wet thickness of the coated layer was 10 μm. The coated matter was dried by passing through the 9th and 10th zones and wound up into a roll. The rolled web was cut into suitable size to prepare Ink-jet Recording Sheet 202.

1st zone: 30° C., 30 seconds

2nd zone: 45° C., 30 seconds

3rd zone: 60° C., 30 seconds

4th zone: 60° C., 30 seconds

5th zone: 60° C., 30 seconds

6th zone: 60° C., 30 seconds

7th zone: 60° C., 30 seconds

8th zone: 60° C., 30 seconds

9th zone: 40° C., 30 seconds

10th zone: 25° C., 90 seconds

In all zones other than the 10th zone, the average relative humidity of the air was not more than 30%. The 10th zone is a humidity conditioning zone in which the relative humidity of the air was 40 through 60%

The volume of pores in thus prepared ink-jet recording sheet was 23 ml per square meter of the recording sheet.

It was found as a result of measurement of the layer surface temperature that from the 1st to 5th zones were constant-rate drying zone and after the half way of the 6th zone was falling-rate drying zone. The finishing point of the drying, where the surface temperature was agreed with that of the air, was the 8th zone. The moisture content of the coated layer at the exit of each of the zone were as follows; the moisture content was represented by a relative value when the volume of pores=23 ml/m² was set as 100.

5th zone: 210

6th zone: 120

7th zone: 50

8th zone: 0

<Preparation of Ink-Jet Recording Sheet 203 (Inventive Sample)>

The foregoing Coating Liquid 1 was coated on the paper support in the same manner as in Ink-jet Recording Sheet 1 of Example 1. After the coating, the coated support was irradiated by ultraviolet rays with energy of 2 kJ/cm² by the metal halide lamp, dried by air of 80° C. and wound up into a roll. After standing for 4 hours at 23° C., an aqueous triethanolamine solution was over coated by the spray coater so that the coated amount (g/m²) is the same as that in Ink-jet Recording Sheet 11, dried for one minute by air of 40° C., and wound up as a roll. The wet thickness of the layer was 10 μm. Then the web was cut into suitable size. Thus Ink-jet Recording Sheet 203 was prepared.

<Preparation of Ink-Jet Recording Sheet 205 (Inventive Sample)>

Ink-jet Recording Sheet 205 was prepared in the same manner as in Ink-jet Recording Sheet 202 except that an aqueous solution of polyarylamine hydrochloride, PAA-HCL-10L produced by Nitto Bouseki Co., Ltd., was online over coated by the spray coater so that the coated amount (g/m²) was the same as that in Ink-jet Recording Sheet 2. The wet thickness of the layer was 10 μm.

<Preparation of Ink-Jet Recording Sheet 206 (Inventive Sample)>

Ink-jet Recording Sheet 206 was prepared in the same manner as in Ink-jet Recording Sheet 203 except that the aqueous solution of polyacrylamine hydrochloride, PAA-HCL-10L produced by Nitto Bouseki CO., Ltd., was online over coated by the spray coater after the standing for 4 hours at 23° C. so that the coated amount (g/m²) was the same as that in Ink-jet Recording Sheet 2. The wet thickness of the layer was 10

Preparation of Ink-Jet Recording Sheet 208 (Inventive Sample)

Ink-jet Recording Sheet 208 was prepared in the same manner as in Ink-jet Recording Sheet 202 except that an aqueous solution of sulfur-containing compound 1-2 was over coated by the spray coater at the exit of the 8^{th} zone so that the coated amount (g/m²) was the same as that in Ink-jet Recording Sheet 3. The wet thickness of the layer was 10 am.

<Preparation of Ink-Jet Recording Sheet 209 (Inventive Sample)>

Ink-jet Recording Sheet 209 was prepared in the same manner as in Ink-jet Recording Sheet 203 except that the aqueous solution of sulfur-containing compound 1-2 was over coated by the spray coater after the standing for 4 hours at 23° C. so that the coated amount (g/m²) was the same as that in Ink-jet Recording Sheet 3. The wet thickness of the layer was 10 μm.

<Preparation of Ink-Jet Recording Sheet 211 (Inventive Sample)>

Ink-jet Recording Sheet 211 was prepared in the same manner as in Ink-jet Recording Sheet 202 except that an aqueous solution of hindered amine compound, Adecastab LX-332 produced by Asahi Denka Kogyo Co., Ltd., was online over coated by the spray coater at the exit of the 8th zone so that the coated amount (g/m²) was the same as that in Ink-jet Recording Sheet 4. The wet thickness of the layer was 10 am.

<Preparation of Ink-Jet Recording Sheet 212 (Inventive Sample)>

Ink-jet Recording Sheet 212 was prepared in the same manner as in Ink-jet Recording Sheet 203 except that an aqueous solution of hindered amine compound, Adecastab LX-332 produced by Asahi Denka Kogyo Co., Ltd., was online over coated by the spray coater after the standing for 4 hours at 23° C. so that the coated amount (g/m²) was the same as that in Ink-jet Recording Sheet 4. The wet thickness of the layer was 10 μm.

<Preparation of Ink-Jet Recording Sheet 214 (Inventive Sample)>

Ink-jet Recording Sheet 214 was prepared in the same manner as in Ink-jet Recording Sheet 202 except that an aqueous solution of hindered phenol compound, Adecastab LX-802 produced by Asahi Denka Kogyo Co., Ltd., was online over coated by the spray coater at the exit of eighth zone so that the coated amount (g/m²) was the same as that in Ink-jet Recording Sheet 5. The wet thickness of the layer was 10 μm.

<Preparation of Ink-Jet Recording Sheet 215 (Inventive Sample)>

Ink-jet Recording Sheet 215 was prepared in the same manner as in Ink-jet Recording Sheet 203 except that an aqueous solution of hindered phenol compound, Adecastab LX-802 produced by Asahi Denka Kogyo Co., Ltd., was online over coated by the spray coater after the standing for 4 hours at 23° C. so that the coated amount (g/m²) was the same as that in Ink-jet Recording Sheet 5. The wet thickness of the layer was 10 μm.

<Preparation of Ink-Jet Recording Sheet 217 (Inventive Sample)>

Ink-jet Recording Sheet 217 was prepared in the same manner as in Ink-jet Recording Sheet 202 except that an aqueous solution of zirconium acetate, Zircosol ZA produced by Daiichi Kigenso Kagaku Kogyo Co., Ltd., was online over coated by the spray coater at the exit of the 8th zone so that the coated amount (g/m²) was the same as that in Ink-jet Recording Sheet 6. The wet thickness of the layer was 10 μm.

<Preparation of Ink-Jet Recording Sheet 218 (Inventive Sample)>

Ink-jet Recording Sheet 218 was prepared in the same manner as in Ink-jet Recording Sheet 203 except that an aqueous solution of zirconium acetate, Zircosol ZA produced by Daiichi Kigenso Kagaku Kogyo Co., Ltd., was online over coated by the spray coater after the standing for 4 hours at 23° C. so that the coated amount (g/m²) was the same as that in Ink-jet Recording Sheet 6. The wet thickness of the layer was 10 μm.

<Preparation of Ink-Jet Recording Sheet 220 (Inventive Sample)>

Ink-jet Recording Sheet 220 was prepared in the same manner as in Ink-jet Recording Sheet 202 except that an aqueous solution of hydroxylamine compound A was online over coated by the spray coater at the exit of the 8th zone so that the coated amount (g/m²) was the same as that in Ink-jet Recording Sheet 12. The wet thickness of the layer was 10 μm.

<Preparation of Ink-Jet Recording Sheet 221 (Inventive Sample)>

Ink-jet Recording Sheet 221 was prepared in the same manner as in Ink-jet Recording Sheet 203 except that an aqueous solution of hydroxylamine compound A was online over coated by the spray coater after the standing for 4 hours at 23° C. so that the coated amount (g/m²) was the same as that in Ink-jet Recording Sheet 12. The wet thickness of the layer was 10 Am.

<Preparation of Ink-Jet Recording Sheet 223 (Inventive Sample)>

Ink-jet Recording Sheet 223 was prepared in the same manner as in Ink-jet Recording Sheet 202 except that an aqueous solution of polyvinylamine having a weight average molecular weight of 70,000 was online over coated by the spray coater at the exit of the 8th zone so that the coated amount (g/m²) was the same as that in Ink-jet Recording Sheet 13. The wet thickness of the layer was 10 am.

<Preparation of Ink-Jet Recording Sheet 224 (Inventive Sample)>

Ink-jet Recording Sheet 224 was prepared in the same manner as in Ink-jet Recording Sheet 203 except that an aqueous solution of polyvinylamine having a weight average molecular weight of 70,000 was online over coated by the spray coater after the standing for 4 hours at 23° C. so that the coated amount (g/m²) was the same as that in Ink-jet Recording Sheet 13. The wet thickness of the layer was 10 μm.

<Preparation of Ink-Jet Recording Sheet 226 (Inventive Sample)>

Ink-jet Recording Sheet 226 was prepared in the same manner as in Ink-jet Recording Sheet 202 except that an aqueous solution of sulfur-containing compound 2-3 was online over coated by the spray coater at the exit of the 8th zone so that the coated amount (g/m²) was the same as that in Ink-jet Recording Sheet 14. The wet thickness of the layer was 10 μm.

<Preparation of Ink-Jet Recording Sheet 227 (Inventive Sample)>

Ink-jet Recording Sheet 227 was prepared in the same manner as in Ink-jet Recording Sheet 203 except that an aqueous solution of sulfur-containing compound 2-3 was online over coated by the spray coater after the standing for 4 hours at 23° C. so that the coated amount (g/m²) was the same as that in Ink-jet Recording Sheet 14. The wet thickness of the layer was 10 μm.

<Preparation of Ink-Jet Recording Sheet 229 (Inventive Sample)>

Ink-jet Recording Sheet 229 was prepared in the same manner as in Ink-jet Recording Sheet 202 except that an aqueous solution of hydroquinone diether compound A was online over coated by the spray coater at the exit of the 8th zone so that the coated amount (g/m²) was the same as that in Ink-jet Recording Sheet 15. The wet thickness of the layer was 10 Am.

<Preparation of Ink-Jet Recording Sheet 230 (Inventive Sample)>

Ink-jet Recording Sheet 230 was prepared in the same manner as in Ink-jet Recording Sheet 203 except that an aqueous solution of hydroquinone diether compound A was online over coated by the spray coater after the standing for 4 hours at 23° C. so that the coated amount (g/m²) was the same as that in Ink-jet Recording Sheet 15. The wet thickness of the layer was 10 μm.

<Preparation of Ink-Jet Recording Sheet 231 (comparative Sample)>

A coating liquid the same as in Ink-jet Recording Sheet 7 of Example 1 except that the polyallylamine hydrochloride was omitted was coated. The coated web was passed for 15 seconds through the cooling zone maintained at 5° C. so that the surface temperature of the coated layer was lowered by 13° C. Then the coated layer was dries by passed through the 1st through 8^{th} zones while blowing air having the foregoing temperature. An aqueous solution of polyallylamine hydrochloride was online over coated by the spray coater at the exit of the 8th zone so that the coated amount (g/m²) was the same as that in Ink-jet Recording Sheet 7. The wet thickness of the layer was 10 μm. Then the web was dried by passing through the ninth and tenth zones and wound up into a roll. The rolled web was cut into a suitable size to prepare Ink-jet Recording Sheet 231.

Evaluation of Properties of the Ink-Jet Recording Sheet

The light resistance, weather resistance of binder, cracking of layer, breaking by bending of layer, and ink absorption ability of the above-prepared Ink-jet Recording Sheets, Ink-jet Recording Sheet 11, Ink-jet Recording Sheets 2 through 6, and Ink-jet Recording Sheets 12 through 15 of Example 1 were each evaluated in the same manner as in Example 1. Moreover, the following evaluation of the weather resistance of the binder, hereinafter referred to as the additional evaluation of weather resistance 1, was additionally performed to the evaluation in Example 1.

<Additional Evaluation of Weather Resistance of Binder 1>

After the weather resistance evaluation according to Example 1, the samples were further stood in a Xe Fade-o-meter irradiating light of 70,000 lux for 24 hours, and then appearance of cracks formed on the surface was observed visually or through a loupe with respect to 0.1 m² of each of the sample.

A: Any minute crack less than 0.5 mm was almost not observed through the loupe; no problem for practical use.

B: Four to ten minute cracks less than 0.5 mm were observed through the loupe; no problem for practical use.

C: Eleven or more minute cracks less than 0.5 mm were observed through the loupe; no problem for practical use.

Results of the evaluation are shown in Table 2.

TABLE 2

| | | Weather | | | | | |
|---|---|---|---|---|---|---|---|
| | | resistivity of | | | Fractures | | Second |
| | | binder | | | of the | | weather |
| | | Xe | | Cracking | layer | Ink | resist- |
| Sample | Photo- | irradia- | High | of the | caused by | absorb- | ivity of |
| No. | fading | tion | humidity | layer | bending | ability | binder |
| 201 (11) | B | A | A | A | A | A | C |
| 202 | A | A | A | A | A | A | B |
| 203 | A | A | A | A | A | A | C |
| 204 (2) | A | A | A | A | A | A | C |
| 205 | A | A | A | A | A | A | A |
| 206 | A | A | A | A | A | A | B |
| 207 (3) | B | A | A | B | A | A | C |
| 208 | A | A | A | B | A | A | B |
| 209 | A | A | A | A | A | A | C |
| 210 (4) | A | A | A | A | B | A | C |
| 211 | A | A | A | A | B | A | A |
| 212 | A | A | A | A | B | A | B |
| 213 (5) | B | A | A | B | A | A | C |
| 214 | A | A | A | A | B | A | B |
| 215 | A | A | A | A | B | A | C |
| 216 (6) | B | A | A | B | A | A | C |
| 217 | A | A | A | B | B | A | B |
| 218 | A | A | A | B | B | A | C |
| 219 (12) | B | A | A | B | A | A | C |
| 220 | A | A | A | B | A | A | B |
| 221 | A | A | A | B | A | A | C |
| 222 (13) | B | A | A | A | A | A | C |
| 223 | A | A | A | A | A | A | B |
| 224 | A | A | A | A | A | A | C |
| 225 (14) | B | A | A | B | A | A | C |
| 226 | A | A | A | B | A | A | B |
| 227 | A | A | A | B | A | A | C |
| 228 (15) | B | A | A | A | B | B | C |
| 229 | A | A | A | A | B | B | B |
| 230 | A | A | A | A | B | B | C |
| 230 | D | C | C | D | D | C | — |

In Table 2, “Sample No.” represents the number of Ink-jet Recording Sheet. For convenience, Ink-jet Recording Sheet 11 is described as Sample No. 201, Ink-jet Recording Sheets 2 through 6 are each described as Samples 204, 207, 210, 213, and 216, respectively, and Ink-jet Recording Sheets 12 through 15 are described as Samples 219, 222, 225, and 228, respectively. In table 2, the sample No. in Example 1 is shown in parentheses such as Sample No. 201 (11). Ink-jet Recording Sheet 231 was not subjected to the additional evaluation of weather resistance of binder 1 since considerable cracks were observed in the evaluation of weather resistance of binder.

The results of Table 2 show that the online over coating method as the second method gives most preferable results and the over coating method as the third method gives ensuing results among the three methods for providing the compound according to the invention to the porous ink accepting layer. It is understood that the expected effects of the invention cannot be obtained in Ink-jet Recording Sheet 231 which contains no hydrophilic binder containing the polymer crosslinkable by irradiation of the ionizing radiation even when the online over coating method or the second method is applied.

### Example 3

Preparation of Ink-Jet Recording Sheet

<Preparation of Ink-Jet Recording Sheet 301 (Inventive Sample)>

Ink-jet Recording Sheet 301 was prepared in the same manner as in Ink-jet Recording Sheet 2 except that the amount of energy applied after the coating by the metal halide lamp was changed to 2.0×10⁴ kJ/cm².

<Preparation of Ink-Jet Recording Sheet 302 (Inventive Sample)>

Ink-jet Recording Sheet 302 was prepared in the same manner as in Ink-jet Recording Sheet 3 except that the amount of energy applied after the coating by the metal halide lamp was changed to 2.0×10⁴ kJ/cm².

<Preparation of Ink-Jet Recording Sheet 303 (Inventive Sample)>

Ink-jet Recording Sheet 303 was prepared in the same manner as in Ink-jet Recording Sheet 4 except that the amount of energy applied after the coating by the metal halide lamp was changed to 2.0×10⁴ kJ/cm².

<Preparation of Ink-Jet Recording Sheet 304 (Inventive Sample)>

Ink-jet Recording Sheet 304 was prepared in the same manner as in Ink-jet Recording Sheet 5 except that the amount of energy applied after the coating by the metal halide lamp was changed to 2.0×10⁴ kJ/cm².

<Preparation of Ink-Jet Recording Sheet 305 (Inventive Sample)>

Ink-jet Recording Sheet 305 was prepared in the same manner as in Ink-jet Recording Sheet 6 except that the amount of energy applied after the coating by the metal halide lamp was changed to 2.0×10⁴ kJ/cm².

<Preparation of Ink-Jet Recording Sheet 306 (Inventive Sample)>

Ink-jet Recording Sheet 306 was prepared in the same manner as in Ink-jet Recording Sheet 11 except that the amount of energy applied after the coating by the metal halide lamp was changed to 2.0×10⁴ kJ/cm².

<Preparation of Ink-Jet Recording Sheet 307 (Inventive Sample)>

Ink-jet Recording Sheet 307 was prepared in the same manner as in Ink-jet Recording Sheet 12 except that the amount of energy applied after the coating by the metal halide lamp was changed to 2.0×10⁴ kJ/cm².

<Preparation of Ink-Jet Recording Sheet 308 (Inventive Sample)>

Ink-jet Recording Sheet 308 was prepared in the same manner as in Ink-jet Recording Sheet 13 except that the amount of energy applied after the coating by the metal halide lamp was changed to 2.0×10⁴ kJ/cm².

<Preparation of Ink-Jet Recording Sheet 309 (Inventive Sample)>

Ink-jet Recording Sheet 309 was prepared in the same manner as in Ink-jet Recording Sheet 14 except that the amount of energy applied after the coating by the metal halide lamp was changed to 2.0×10⁴ kJ/cm².

<Preparation of Ink-Jet Recording Sheet 310 (Inventive Sample)>

Ink-jet Recording Sheet 310 was prepared in the same manner as in Ink-jet Recording Sheet 15 except that the amount of energy applied after the coating by the metal halide lamp was changed to 2.0×10⁴ kJ/cm².

The light resistance, weather resistance of binder, cracking of layer, breaking by bending of layer, and ink absorption ability of the above-prepared Ink-jet Recording Sheets were each evaluated in the same manner as in Example 1. Moreover, the following evaluation to the weather resistance of the binder, hereinafter referred to as the additional evaluation of weather resistance 2, was performed additionally to the evaluation in Example 1.

<Additional evaluation of weather resistance of binder 2>

After the weather resistance evaluation according to Example 1, the samples were further stood for 24 hours under the condition of a temperature of 40° C. and a relative humidity of 70%, and then appearance of cracks formed on the surface was observed visually or through a loupe with respect to 0.1 m² of each of the sample.

A: Any minute crack less than 0.5 mm was almost not observed (not more than 3) through the loupe; no problem for partical use.

B: Four to ten minute cracks less than 0.5 mm were observed through the loupe; no problem for practical use.

C: Eleven or more minute cracks less than 0.5 mm were observed through the loupe; no problem for practical use. Results of the evaluation were shown in Table 3.

TABLE 3

| | | Weather | | | | | |
|---|---|---|---|---|---|---|---|
| | | resistivity of | | | Fractures | | Second |
| | | binder | | | of the | | weather |
| | | Xe | | Cracking | layer | Ink | resist- |
| Sample | Photo- | irradia- | High | of the | caused by | absorb- | ivity of |
| No. | fading | tion | humidity | layer | bending | ability | binder |
| 301 | A | A | A | A | A | A | B |
| 302 | A | A | A | B | A | A | C |
| 303 | A | A | A | A | B | A | B |
| 304 | A | A | A | A | B | A | C |
| 305 | A | A | A | B | A | A | C |
| 306 | A | A | A | A | A | A | B |
| 307 | A | A | A | B | A | A | C |
| 308 | A | A | A | A | A | A | C |
| 309 | A | A | A | B | A | A | C |
| 310 | A | A | A | A | B | B | C |

The “Sample No.” in Table 3 represents number of Ink-jet Recording Sheet. It is understood from the results shown in Table 3 that the samples are excellent in the light discoloration resistance and on the level of “no problem for practical use” in the weather resistance of binder, cracking of the layer, breaking of the layer by bending and ink absorption ability. Moreover, light discoloration resistance and the weather resistance of binder under under the high humidity are improved.

An ink-jet recording sheet with high ink absorbability can be provided by the invention, which is excellent in resistance of photo-fading of color and resistance to cracking during the production process (coating and drying) and resistance to fracturing by bending by handling after drying.

1. An ink-jet recording sheet comprising a support and an ink accepting porous layer provided on the support, wherein the ink accepting porous layer comprises a hydrophilic binder containing a polymer compound crosslinked via irradiation of ionizing radiation, micro particles, and at least one component selected from the group consisting of (A) a nitrogen-containing compound, (B) a sulfur-containing compound, (C) a phenol compound and (D) a polyvalent metal salt.

2. The ink-jet recording sheet of claim 1, wherein the micro particles have an average diameter of from 5 to 200 nm.

3. The ink-jet recording sheet of claim 1, wherein a ratio of the micro particles to the hydrophilic binder is from 1:2 to 1:50 by weight.

4. The ink-jet recording sheet of claim 3, wherein the ratio of the micro particles to the hydrophilic binder is from 1:5 to 1:15 by weight.

5. The ink-jet recording sheet of claim 1, wherein the polymer compound crosslinked via irradiation of ionizing radiation is a polymer compound formed by crosslinking a hydrophilic resin having a dimer formable photosensitive group formed via irradiation of ionizing radiation.

6. The ink-jet recording sheet of claim 1, wherein the nitrogen-containing compound is at least one selected from the group consisting of a hindered amine compound, a hydroxylamine compound and a water-soluble aliphatic tertiary amine compound.

7. The ink-jet recording sheet of claim 1, wherein the nitrogen-containing compound is a polyallylamine compound.

8. The ink-jet recording sheet of claims 1, wherein the nitrogen-containing compound is a tertiary amine compound.

9. The ink-jet recording sheet of claim 1, wherein the sulfur compound is a compound represented by Formula 1 or Formula 2:
R—S—R′ Formula 1
wherein R and R′ are each an alkyl group or an aryl group, 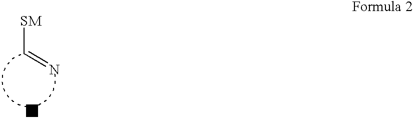
wherein M is a hydrogen atom, an ammonium ion or a metal atom; X is a group of non-metal atoms necessary to form a five- through seven-member ring.

10. The ink-jet recording sheet of claim 1, wherein the polyvalent metal salt is a water-soluble salt of one selected from the group consisting of cesium, magnesium, aluminum and zirconium.

11. The ink-jet recording sheet of claim 1, wherein the phenol compound is a hindered phenol compound or a hydroquinone diether compound.

12. The ink-jet recording sheet of claim 1, wherein the polymer compound is a polymer compound crosslinked through side chains of a hydrophilic polymer compound by irradiation via ionizing radiation, the hydrophilic compound having a polymerization degree of not less than 300 and the plurality of side chains on a main chain.

13. The ink-jet recording sheet of claim 1, wherein the ink accepting porous layer further comprises polyvinyl alcohol or its derivative.

14. A preparation method of an ink-jet recording sheet comprising a step of (a) forming a porous layer on a support in which the porous layer comprises a hydrophilic binder containing a polymer compound crosslinked via irradiation of ionizing radiation, micro particles, and at least one component selected from the group consisting of (A) a nitrogen-containing compound, (B) a sulfur-containing compound, (C) a phenol compound and (D) a polyvalent metal salt.

15. The preparation method of claim 14, wherein the step of (a) forming a porous layer comprises the steps;
(b) forming a coated film comprising a polymer compound and micro particles, on the support, and
(C) crosslinking the polymer compound via irradiation of ionizing radiation to the polymer compound.

16. The preparation method of claim 15, wherein the step of (a) forming a porous layer comprises, after the step (c), the step;
(d) providing coated film with the a coating liquid containing at least one component selected from the group consisting of (A) a nitrogen-containing compound, (B) a sulfur-containing compound, (C) a phenol compound and (D) a polyvalent metal salt.

17. The preparation method of claim 16, wherein the step of (d) is conducted after a time that water content of the coated film becomes less than the volume of pores in the ink accepting porous layer, during drying of the coated film, or after completion of drying of the coated film.

18. The preparation method of claim 16, wherein the step of (d) is conducted after completion of drying of the coated film.

19. The preparation method of claims 16, wherein the polymer compound crosslinked by irradiation via ionizing radiation is a polymer compound formed by crosslinking a hydrophilic resin having a dimer formable photosensitive group formed via irradiation of ionizing radiation.

20. The preparation method of claim 16, wherein the nitrogen-containing compound is at least one selected from the group consisting of a hindered amine compound, a hydroxylamine compound and a water-soluble aliphatic tertiary amine compound.

21. The preparation method of claim 16, wherein the nitrogen-containing compound which is an polyallylamine compound.

22. The preparation method of claim 16, wherein the nitrogen-containing compound is a tertiary amine compound.

23. The preparation method of claim 16, wherein the sulfur compound is a compound represented by Formula 1 or Formula 2:
R—S—R′ Formula 1
wherein R and R′ are each an alkyl group or an aryl group, 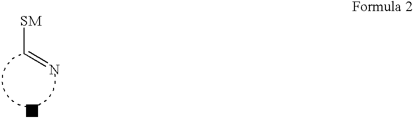
wherein M is a hydrogen atom, an ammonium ion or a metal atom; X is a group of non-metal atoms necessary to form a five- through seven-member ring.

24. The preparation method of claim 16, wherein the polyvalent metal salt is a water-soluble salt of one selected from the group consisting of cesium, magnesium, aluminum and zirconium.

25. The preparation method of claim 16, wherein the phenol compound is a hindered phenol compound or a hydroquinone diether compound.

26. The preparation method of claim 16, wherein the polymer compound is a polymer compound crosslinked through side chains of a hydrophilic polymer compound having a polymerization degree of not less than 300 and the plurality of side chains on a main chain by irradiation via ionizing radiation.

27. The preparation method of claim 16, wherein the ink accepting porous layer further comprises polyvinyl alcohol or its derivative.
